(19) United States
(12) Patent Application Publication
(10) Pub. No.: US 2026/0271124 A1
(43) Pub. Date: Sep. 10, 2026

(54) ENHANCED SMALL DATA TRANSMISSION AND INACTIVE STATE OPERATIONS

(71) Applicant: QUALCOMM Incorporated, San Diego, CA (US)

(72) Inventors: Yan Zhou, San Diego, CA (US); Kiran Venugopal, Green Brook, NJ (US)

(21) Appl. No.: 19/070,115

(22) Filed: Mar. 4, 2025

(51) Int. Cl. H04W 76/27; H04L 5/00; H04W 24/10; H04W 56/00; H04W 74/0833; H04W 76/30

(52) U.S. Cl. CPC H04W 76/27; H04L 5/0048; H04W 24/10; H04W 56/001; H04W 74/0833; H04W 76/30

(57) ABSTRACT

This disclosure provides systems, methods, and devices for wireless communication that support enhanced small data transmission (SDT) operations. In a first aspect, a device for wireless communication includes at least one processor and a memory coupled to the at least one processor. The at least one processor is configured to receive a first SDT configuration for a first cell and a second SDT configuration for a second cell; transition from a connected state to an inactive state responsive to receiving a release transmission from the first cell; and transmit, while in the inactive state, a SDT transmission to the second cell based on the second SDT configuration. Other aspects and features are also claimed and described.

### TECHNICAL FIELD

Aspects of the present disclosure relate generally to wireless communication systems, and more particularly, to enhanced small data transmission (SDT) operations. Some features may enable and provide improved communications, including reduce latency and failures and improved SDT operations when operating in an inactive state and/or for mobility scenarios.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks may be multiple access networks that support communications for multiple users by sharing the available network resources.

A wireless communication network may include several components. These components may include wireless communication devices, such as base stations (or node Bs) that may support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on a downlink to a UE or may receive data and control information on an uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In one aspect of the disclosure, a method of wireless communication includes receiving a first SDT configuration for a first cell and a second SDT configuration for a second cell; transitioning from a connected state to an inactive state responsive to receiving a release transmission from the first cell; and transmitting, while in the inactive state, a SDT transmission to the second cell based on the second SDT configuration. Other aspects and features are also claimed and described.

In an additional aspect of the disclosure, an apparatus configured for wireless communication is disclosed. The apparatus includes at least one processor, and a memory coupled to the at least one processor. The at least one processor is configured to receive a first SDT configuration for a first cell and a second SDT configuration for a second cell; transition from a connected state to an inactive state responsive to receiving a release transmission from the first cell; and transmit, while in the inactive state, a SDT transmission to the second cell based on the second SDT configuration.

Other aspects, features, and implementations will become apparent to those of ordinary skill in the art, upon reviewing the following description of specific, exemplary aspects in conjunction with the accompanying figures. While features may be discussed relative to certain aspects and figures below, various aspects may include one or more of the advantageous features discussed herein. In other words, while one or more aspects may be discussed as having certain advantageous features, one or more of such features may also be used in accordance with the various aspects. In similar fashion, while exemplary aspects may be discussed below as device, system, or method aspects, the exemplary aspects may be implemented in various devices, systems, and methods.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating example details of an example wireless communication system according to one or more aspects.

FIG. 2 is a block diagram illustrating examples of a base station and a user equipment (UE) according to one or more aspects.

FIGS. 3A and 3B are each a diagram of an example of small data transmission operations according to one or more aspects.

FIG. 4 is a block diagram illustrating an example wireless communication system that supports enhanced small data transmission operations according to one or more aspects.

FIG. 5 is a timing diagram illustrating an example process that supports enhanced small data transmission operations according to one or more aspects.

FIG. 6 is a timing diagram illustrating an example process that supports enhanced small data transmission operations according to one or more aspects.

FIGS. 7A-7D is a timing diagram illustrating an example process that supports enhanced small data transmission operations according to one or more aspects.

FIGS. 8A and 8B is a timing diagram illustrating an example process that supports small data transmission operations according to one or more aspects.

FIG. 9 is a diagram illustrating an example process that supports enhanced small data transmission operations according to one or more aspects.

FIG. 10 is a flow diagram illustrating an example process that supports enhanced small data transmission operations according to one or more aspects.

FIG. 11 is a block diagram of an example UE that supports enhanced small data transmission operations according to one or more aspects.

Like reference numbers and designations in the various drawings indicate like elements.

### DETAILED DESCRIPTION

The detailed description set forth below, in connection with the appended, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

This disclosure relates generally to providing or participating in authorized shared access between two or more wireless devices in one or more wireless communications systems, also referred to as wireless communications networks. In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS, LTE, and NR are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP LTE is a 3GPP project which was aimed at improving UMTS mobile phone standard. The 3GPP may define specifications for the next generation of mobile networks, mobile systems, and mobile devices. The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces. 5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ~1 M nodes/km²), ultra-low complexity (e.g., ~10 s of bits/sec), ultra-low energy (e.g., ~10+ years of battery life), and deep coverage with the capability to reach challenging locations; (2) including mission-critical control with strong security to safeguard sensitive personal, financial, or classified information, ultra-high reliability (e.g., ~99.9999% reliability), ultra-low latency (e.g., ~1 millisecond (ms)), and users with wide ranges of mobility or lack thereof; and (3) with enhanced mobile broadband including extreme high capacity (e.g., ~10 Tbps/km²), extreme data rates (e.g., multi-Gbps rate, 100+ Mbps user experienced rates), and deep awareness with advanced discovery and optimizations.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHz-300 GHz) which is identified by the International Telecommunications Union (ITU) as a “mmWave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band. 5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD or TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHz, subcarrier spacing may occur with 120 kHz over a 500 MHz bandwidth.

The scalable numerology of 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements, etc. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, aggregated or dis-aggregated deployments, end-user devices, etc. of varying sizes, shapes, and constitution.

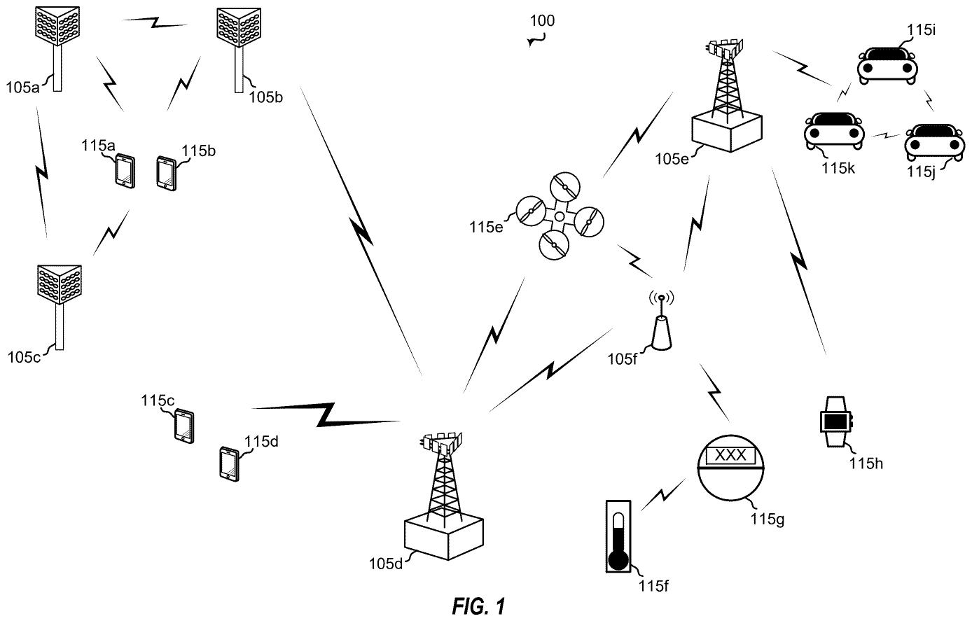

FIG. 1 is a block diagram illustrating details of an example wireless communication system according to one or more aspects. The wireless communication system may include wireless network 100. Wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with one or more UEs and may also be referred to as an evolved node B (eNB), a next generation eNB (gNB), an access point, and the like. Each base station 105 may provide communication coverage for a particular geographic area. In 3GPP, the term “cell” may refer to this particular geographic coverage area of a base station or a base station subsystem serving the coverage area, depending on the context in which the term is used. In implementations of wireless network 100 herein, base stations 105 may be associated with a same operator or different operators (e.g., wireless network 100 may include a plurality of operator wireless networks). Additionally, in implementations of wireless network 100 herein, base station 105 may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a drone, a multi-copter, a quad-copter, a smart energy or security device, a solar panel or solar array, municipal lighting, water meter, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100 A UE may also be a machine specifically configured for connected communication, including machine type communication (MTC), enhanced MTC (eMTC), narrowband IoT (NB-IoT) and the like. UEs 115e-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 100 may occur using wired or wireless communication links.

In operation at wireless network 100, base stations 105a-105c serve UEs 115a and 115b using 3D beamforming and coordinated spatial techniques, such as coordinated multipoint (CoMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of implementations supports mission critical communications with ultra-reliable and redundant links for mission critical devices, such UE 115e, which is a drone. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD communications or low-latency FDD communications, such as in a vehicle-to-vehicle (V2V) mesh network between UEs 115i-115k communicating with macro base station 105e.

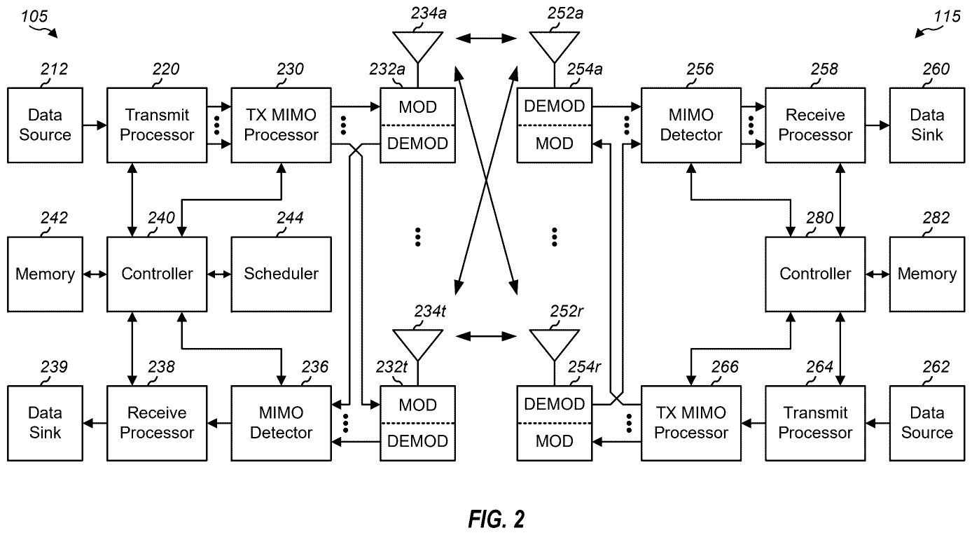

FIG. 2 is a block diagram illustrating examples of base station 105 and UE 115 according to one or more aspects. Base station 105 and UE 115 may be any of the base stations and one of the UEs in FIG. 1. For a restricted association scenario (as mentioned above), base station 105 may be small cell base station 105f in FIG. 1, and UE 115 may be UE 115c or 115d operating in a service area of base station 105f, which in order to access small cell base station 105f, would be included in a list of accessible UEs for small cell base station 105f. Base station 105 may also be a base station of some other type. As shown in FIG. 2, base station 105 may be equipped with antennas 234a through 234t, and UE 115 may be equipped with antennas 252a through 252r for facilitating wireless communications.

At base station 105, transmit processor 220 may receive data from data source 212 and control information from controller 240, such as a processor. The control information may be for a physical broadcast channel (PBCH), a physical control format indicator channel (PCFICH), a physical hybrid-ARQ (automatic repeat request) indicator channel (PHICH), a physical downlink control channel (PDCCH), an enhanced physical downlink control channel (EPDCCH), an MTC physical downlink control channel (MPDCCH), etc. The data may be for a physical downlink shared channel (PDSCH), etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) MIMO processor 230 may perform spatial processing (e.g., precoding) on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, antennas 252a through 252r may receive the downlink signals from base station 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to controller 280, such as a processor.

On the uplink, at UE 115, transmit processor 264 may receive and process data (e.g., for a physical uplink shared channel (PUSCH)) from data source 262 and control information (e.g., for a physical uplink control channel (PUCCH)) from controller 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Receive processor 238 may provide the decoded data to data sink 239 and the decoded control information to controller 240.

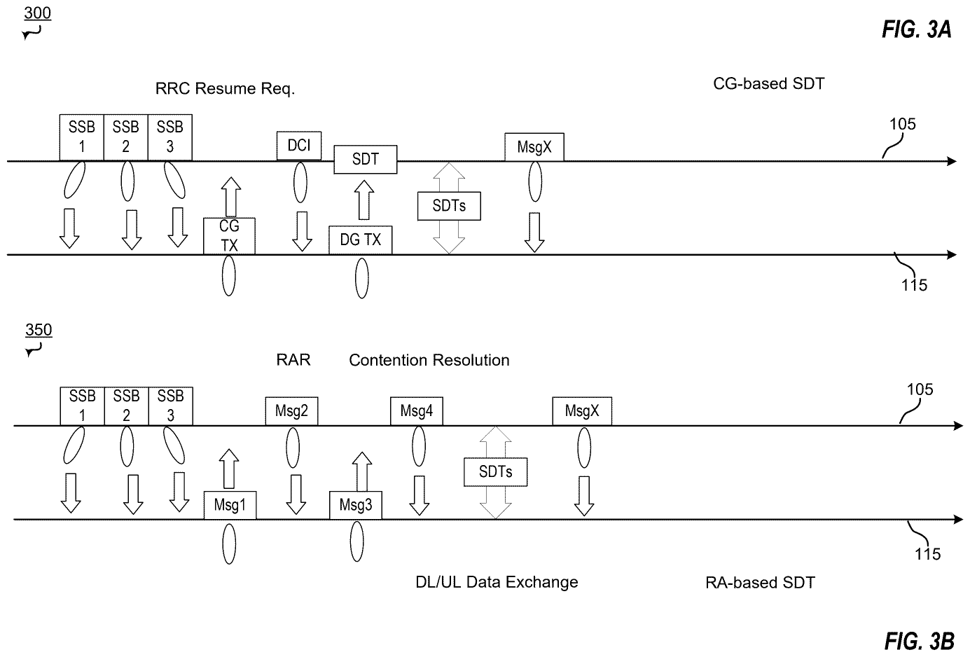

Controllers 240 and 280 may direct the operation at base station 105 and UE 115, respectively. Controller 240 or other processors and modules at base station 105 or controller 280 or other processors and modules at UE 115 may perform or direct the execution of various processes for the techniques described herein, such as to perform or direct the execution illustrated in FIGS. 3-13, or other processes for the techniques described herein. Memories 242 and 282 may store data and program codes for base station 105 and UE 115, respectively. Scheduler 244 may schedule UEs for data transmission on the downlink or the uplink.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel or the acknowledge/negative-acknowledge (ACK/NACK) feedback for its own transmitted packets as a proxy for collisions.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

A UE often generates only a small amount of data across a burst in a data session. This type of data traffic can occur in or across all verticals including mobile broadband (MBB) and IoT. Example of such small data bursts include data bursts for instant messing software, social media software, wearable IoT devices, and etc. It is beneficial for a network to allow a UE to transmit mobile originating (MO) uplink small data in an RRC_INACTIVE state without the UE having to move to an RRC_CONNECTED state and/or receive downlink small data in an RRC_INACTIVE state without the UE having to move to an RRC_CONNECTED state.

For example, the network may enable transmission of uplink data on pre-configured PUSCH resources from the RRC_INACTIVE state under certain conditions, such as when time alignment (TA) value is valid. To illustrate, a TA timer (TAT) may be used to track a validity of the TA value which may indicate that the uplink timing settings are valid. As another example, the network may enable reception of downlink on pre-configured PDSCH resources from the RRC_INACTIVE state under corresponding downlink conditions.

The network (e.g., eNB or gNB) configures dedicated SDT uplink resources for the UE (e.g., for a signal radio bearer (SRB) or a data radio bearer (DRB) thereof) via RRC dedicated signaling. Such signaling can occur when the UE is in an RRC_CONNECTED, RRC_IDLE, or in RRC_INACTIVE mode.

In the RRC_INACTIVE state, if the UE has small data to send and it has valid settings, such as value uplink timing settings, it can request a small data transfer or transfers without transitioning to the RRC Connected state.

The UE may then transmit the small data (i.e., in a small data transmission) via the SDT configuration. After the UE's transmission over the configured resource, it monitors the SDT search space for the network's response.

For NR UL small data transmission, preconfigured uplink resource can be configured to UE for subsequent uplink data transmission when the first uplink small data is transmitted via 2-step/4-step Random Access Channel (RACH) procedure or via configured grants. The UE receives the preconfigured uplink resource configuration and transmits subsequent UL packet in the preconfigured resource without entering RRC_CONNECTED mode. This has the benefit of power saving to keep UE in RRC_INACTIVE state for subsequent data transmission without entering RRC_CONNECTED.

It has been proposed for Release 17 to enable both configured grant (CG)-based SDT operations and random access (RA)-based SDT operations for UEs in an inactive state, i.e., RRC INACTIVE. In CG-based SDT operations, a UE sends a RRC resume request in a pre-configured CG to its prior serving cell if the serving cell has provided the UE with a CG-SDT configuration for this cell and the corresponding TA timer remains valid. The small data transmission operation may then follow with a transmission scheduled by direct grant while the UE is in the inactive state.

In RA-based SDT operations, a UE initiates a 4-Step random access channel (RACH) procedure with a RRC resume request in Msg3 when the TA timer is not valid to update its TA timer to enable future SDT operations and/or when the UE has not received a CG-SDT configuration. The small data transmission operation may then follow with a transmission scheduled by direct grant while the UE is in the inactive state and after the UE has received the updated TA timer information. Alternatively, the UE may move to a new cell that has not provided it with a SDT configuration, and the UE may need to perform a RACH procedure to connect, receive a SDT configuration, perform a release operation, and then the UE can be configured to perform SDT operations from an inactive state.

The current proposed framework for SDT operations from an inactive state does not account or enable SDT operations for UE mobility scenarios. That is, if a UE moves outside of range of the prior serving cell which provided the SDT configuration, the UE cannot use SDT operations with a new cell. Additionally, the current proposed framework for SDT operations only allows one configuration to be signaled and stored, and this configuration is released upon many event triggers at the UE, such as TA timer expiration, handover, mobility scenarios, RRC transitions, etc.

The proposed Release 17 SDT operations framework is not suitable for UE mobility in an inactive state and has additional limitations due to being a mere extension of prior SDT frameworks to utilize configured grant resources for SDT operations (e.g., to secure a direct grant for a SDT). As one example for CG-based SDT operations, because the CG resources for SDTs are configured via dedicated signaling in a RRCRelease message from the serving cell, the CG resources are valid only within the cell where the UE received the RRCRelease message, which causes the UE to be in an RRC_INACTIVE state. When the inactive UE moves to a new cell and intends to initiate a SDT, the inactive UE can only trigger a RA-based SDT, which involves more signaling overhead and more latency, because the UE does not have a CG-SDT configuration for the new cell.

Additionally, CG-based SDT operations are only available to the UE when the TA timer is valid. Otherwise, the UE has to fall back to RA-based SDT operations. In the proposed framework, the CG-SDT TA timer is configured and started by the RRCRelease message, which also carries the CG-SDT configuration for the cell. Currently, there is no way to extend or update the CG-SDT TA timer (e.g., from the inactive state without fully connecting to the network) or to apply the CG-SDT TA timer for other cells to utilize CG-based SDT operations as opposed to RA-based SDT operations.

Currently, the proposed framework for SDT operations in an inactive state has no beam management functionality, which limits practical applications and mobility applications and enhancements. A UE in an inactive state or a UE with a SDT configuration has no framework for adjusting beams to improve performance, reduce errors, or recover from a beam failure. For example, UE-specific beam management, TCI indication, and BFR are not supported during or for SDT operations. Because of this lack of functionality, a UE in an idle or inactive state may have to trigger a lengthy initial access process for transmitting data on a new beam. In one example scenario, if the initially selected beam for a CG or RA-based SDT operations fails, e.g. the initial beam gets blocked or UE moves to a new beam, the SDT and SDT operations will be terminated unsuccessfully, and the UE will switch to the idle mode and release stored UE configurations, including the SDT configuration. A failure can be detected by a UE if a RLC or PRACH maximum retransmission condition has been reached (e.g., max. amount of retransmissions over a particular time) or if no network response is received after the CG-SDT TA timer expires or after the UE sends RRC resume request.

Currently, the proposed framework for SDT operations in an inactive state also has no cell selection/reselection functionality, which limits mobility applications and enhancements. For example, if cell reselection happens during an ongoing SDT procedure (e.g., while a UE is configured for SDT operations in an inactive state and/or attempting a SDT), the SDT operation will be terminated unsuccessfully, and the UE will switch to the idle mode and release the stored SDT configuration information. The UE in the idle mode may have to trigger a lengthy initial access process for transmitting the data it was attempting to transmit via a SDT or SDTs on the newly reselected cell after connection.

Under the proposed framework, once UE transitions to inactive mode, the candidate cell configurations for handover and mobility are released. To illustrate, after receiving a RRCRelease message with SuspendConfig, candidate cell configuration information for conditional handover and lower layer mobility are released. If a large amount of traffic arrives after this release and while the UE is in an inactive or non-connected mode, the UE cannot quickly transition to a connected mode with CHO or LTM enabled. The UE will have to connect to the network to receive the data and then receive the SDT configuration again, which impacts both overhead and latency.

In the aspects describe herein, various techniques are described for inactive state management, including enhanced SDT operations for inactive state. The enhanced SDT operations for inactive state enable increased mobility for inactive state devices for SDT operations and enable a UE to receive per cell SDT configuration information and for the UE to engage in small data transmissions with one or more different candidate cells that are different from the prior serving cell that the UE was connected to when the UE transitioned from a RRC connected mode to an RRC inactive mode. Additionally, techniques are also described to enable longer SDT sessions through SDT update and synchronization operations and to enable beam switching capability for SDT operations to enable the SDT operations to be more flexible and adapt to changing network conditions and mobility scenarios.

In some aspects, the SDT configuration for a UE can be provided per candidate cell, which may not be the last serving cell transitioning the UE into inactive state, i.e. the cell sending RRCRelease with SuspendConfig, which enables the UE to engage in CG-based SDT operations with other, candidate cells outside of the serving cell which transitioned the UE to the inactive state. Engaging in CG-based SDT operations with cells without having to connect to receive updated SDT configuration information operations reduces latency, network overhead, and UE energy consumption. For example, the UE can utilize the faster and lower power consuming CG-based SDT operations with additional cells as opposed to having to utilize the slower RACH-based SDT operations which have increased latency and network overhead.

In some such aspects, the SDT configuration information described herein includes CG based SDT configuration information, e.g. CG-SDT-Configuration, and the corresponding TA timer configuration information (e.g., CG-SDT TA timer). The SDT configuration information may optionally include one or more of the following: dedicated or collision-free resource information (e.g., CG-SDT-Configuration may be or include collision-free resources, such as dedicated resource to one UE), shared resource information (e.g., CG-SDT-Configuration may be or include resources shared by multiple UEs, a group of UEs, with a potential collision), SDT related search space configuration information (e.g., sdt-SearchSpace), cell-specific configuration information for DL/UL direct grant operation (e.g., ServingCellConfigCommon), or SDT synchronization RACH configuration information (e.g., dedicated RACH configuration information for early UL synchronization).

In the aspects described herein, the SDT configuration information may be provided in different ways. For example, the SDT configuration information for multiple cells, such as per cell SDT configuration information, may be provided by the serving cell. To illustrate, the primary or serving cell may provide SDT configuration information for multiple other candidate cells that are adjacent to the primary/serving cell or part of a cell group. This may be provided in broadcast transmissions (e.g., SUB messages), unicast transmissions (e.g., in a RRCRelease message), or both. As another example, the SDT configuration information for the other candidate cells, the per cell SDT configuration information, may be provided by the other cells themselves, that is not by the primary cell or serving cell. To illustrate, each cell may broadcast its own per cell SDT configuration information, and UEs in range of these other cells (referred to as neighbor or candidate cells for reselection/mobility operations) may receive the per cell SDT configuration information from the cell directly and outside of the primary cell / serving cell the UE is connected to. Alternatively, when the per cell SDT configuration information is provided by the candidate cell itself, the per cell SDT configuration information may be provided in Remaining Minimum System Information (RMSI) or Other System Information (OSI), which can be provided by the network periodically or on-demand. with additional cells as opposed to having to utilize the slower RACH-based SDT. OSI may include or correspond to SIB messages, such as SIB1-9.

Each of FIG. 3A and FIG. 3B illustrate an example of SDT operations for a wireless communication system. In FIG. 3A, CG-based SDT operations are shown for a UE and a network device, and in FIG. 3B RACH-based SDT operations are shown for a UE and a network device. FIG. 3A and FIG. 3B each illustrates a timing diagram of SDT operations for a UE 115 and a base station 105 after the UE 115 has been transitioned to an RRC Inactive state responsive to receiving a RRC Release Message from the base station 105 that includes a Suspend Configuration IE with SDT configuration information.

Referring to FIG. 3A, during operation, the base station 105 (e.g., a gNB or other type of base station) may broadcast SSB transmissions. In the example of FIG. 3A, the base station 105 transmits three SSB transmissions each with a different beam (e.g., antenna configuration) that corresponds to the particular SSB. The SSB transmissions may be “sweeped” and transmitted in different directions. In other aspects, other broadcast or reference signal transmissions may be transmitted by the base station 105.

The UE 115 may be in an inactive or non-connected state, such as RRC Inactive or RRC Idle during the transmission of the SSBs. In the example of FIG. 3A, the UE 115 has been previously configured with CG-based SDT configuration information including one or more configured grants for small data transmission operations, such as in the RRC release message from the base station 105 prior to SSB transmission or in a prior broadcast message from the base station 105, such as a SIB message (e.g., SIB1-SIB9). In some implementations, the UE 115 may receive one or more of the transmitted SSB transmissions and may measure one or more of the SSB transmissions, such as for enhanced mobility or beam operations as described herein. In some implementations, the UE 115 may also be configured with RACH-based SDT configuration information or with SDT configuration information that include both CG and RACH-based configurations. If separate configurations, the two configurations may be received differently. For example, one configuration (e.g., CG or RA) may be received via a SIB message and the other configuration (e.g., the other of CG or RA) may be received via a RRC release message).

Some time after transmission of the SSBs by the base station 105, the UE 115 determines it has data to send, such as small data (e.g., small transmission data) for a small data transmission. The UE 115 may attempt to use one of the configured grants previously configured or signaled by the base station 105 to perform the SDT operations. For example, the UE 115 transmits a RRC resume request during a particular configured grant of the configured grants. The RRC resume request may request a direct grant for use by the UE 115 for a SDT for the small data it has to send. The UE 115 may remain in the RRC inactive state and may not transition to a RRC connected state based on the RRC resume request. For example, the UE 115 may transition to or stay in a RRC Inactive state and transmit SDTs to and/or receive SDTs from the base station 105.

The base station 105 receives the RRC resume request and responds to the UE 115 with a direct grant in a downlink message, such as a DCI or PDCCH. The direct grant may provide the UE 115 with a grant to transmit UL small data to the base station 105. After receiving the downlink transmission from the base station 105, the UE 115 may transmit a SDT in the UL direct grant indicated by the downlink transmission. The base station 105 and/or UE 115 may refrain from performing additional RRC resume request operations associated with transitioning the UE 115 to a connected state based on the RRC resume request and may instead perform SDT operations responsive to the RRC resume request based on the UE 115 utilizing a CG that was configured for SDT operations.

In some implementations, the base station 105 and the UE 115 may engage in additional UL and/or DL small data transmissions as illustrated in FIG. 3A. After completion of the small data transmission or transmissions, the base station 105 may transmit a RRC release message with a suspend configuration, illustrated as Message X (MsgX). The transmission of MsgX may end the small data transmission session. Additionally, in some implementations, MsgX may include additional or updated SDT configuration information. For example, the base station 105 may configure a new small data configuration for the UE 115 or renew the prior configuration with a new TA timer. In some implementations, the UE 115 may transition states after receipt of the RRC release message with a suspend configuration, such as to an idle or inactive state.

Referring to FIG. 3B, during operation, the base station 105 (e.g., a gNB or other type of base station) may broadcast SSB transmissions, similar to as described with reference to FIG. 3A. In the example of FIG. 3B, the base station 105 transmits three SSB transmissions each with a different beam (e.g., antenna configuration) that corresponds to the particular SSB.

The UE 115 may be in an inactive or non-connected state, such as RRC Inactive or RRC Idle during the transmission of the SSBs. In the example of FIG. 3B, the UE 115 has been previously configured with RACH-based small data transmission configuration information, such as in a RRC release message from the base station 105 prior to SSB transmission or in a prior broadcast message from the base station 105, such as a SIB message (e.g., SIB1-SIB9). As compared to FIG. 3A, the UE 115 has not been configured with configured grants for signaling an intent to perform an UL small data transmission. In some implementations, the UE 115 may receive one or more of the transmitted SSB transmissions and may measure one or more of the SSB transmissions, as described with reference to FIG. 3A.

Some time after transmission of the SSBs by the base station 105, the UE 115 determines it has data to send, such as small data (e.g., small transmission data) for a small data transmission. As opposed to being able to use a configured grant as in FIG. 3A to signal the network for a SDT, the UE 115 initiates a RACH procedure (e.g., 4-step RACH procedure) to obtain a direct grant for small data transmission. For example, the UE 115 transmits a RACH request (e.g., a RACH preamble) in Msg1 during a particular configured RACH occasion of the configured RACH occasions for SDT. The RACH request may initiate a RACH procedure or process to enable the UE 115 to perform a SDT for the small data it has to send. The UE 115 may remain in the RRC inactive state and may not transition to a RRC connected state based on the RACH request and subsequent RACH procedure. For example, the UE 115 may transition to or stay in a RRC Inactive state and transmit SDTs to and/or receive SDTs from the base station 105.

The base station 105 receives the RACH request (e.g., RACH preamble) in Msg1 and responds to the UE 115 with a RACH response (RAR) in Msg2. The UE 115 receives the RAR in Msg2, and responds with a RRC resume request in Msg3. The RRC resume request may request a direct grant or other grant related information and/or UL configuration information for use by the UE 115 for a SDT for the small data it has to send. The base station 105 receives the RRC resume request in Msg3 and responds to the UE 115 with a contention resolution message in Msg4. The UE 115 may not transition to a RRC connected state based on the RACH operations for SDT. For example, the UE 115 may transition to or stay in a RRC Inactive state and transmit SDTs to and/or receive SDTs from the base station 105.

After the successful completion of the RACH operations (e.g., RACH operations for SDT), the base station 105 and the UE 115 may engage in UL and/or DL small data transmissions as illustrated in FIG. 3B. After completion of the small data transmission or transmissions, the base station 105 may transmit a RRC release message with a suspend configuration in a MsgX, similar to and as described with reference to FIG. 3A. The transmission of MsgX may end the small data transmission session. Additionally, in some implementations, MsgX may include additional or updated SDT configuration information. For example, the base station 105 may configure a new small data configuration for the UE 115 or renew the prior configuration with a new TA timer. In some implementations, the UE 115 may transition states after receipt of the RRC release message with a suspend configuration, such as to an idle or inactive state.

Although not shown in FIG. 3B, in some implementations the network may provide the UE 115 with a direct grant for a SDT, such as the initial SDT. For example, the base station 105 may provide the UE 115 with a direct grant in Msg4 or in a subsequent transmission after Msg4, such as a subsequent PDCCH or DCI not shown in FIG. 3B and similar the direct grant signaling transmission illustrated in FIG. 3A.

Although FIGS. 3A and 3B illustrate an example where a UE determined it had a UL small data to send, in other implementations, the network may page the UE 115 to indicate it has DL SDT(s) for the UE 115, and the UE 115 may perform CG or RACH-based SDT operations to receive the DL SDT(s). In such examples, the network, such as the base station 105, may provide a DL direct grant in the DCI based on and/or in response to a RRC resume request.

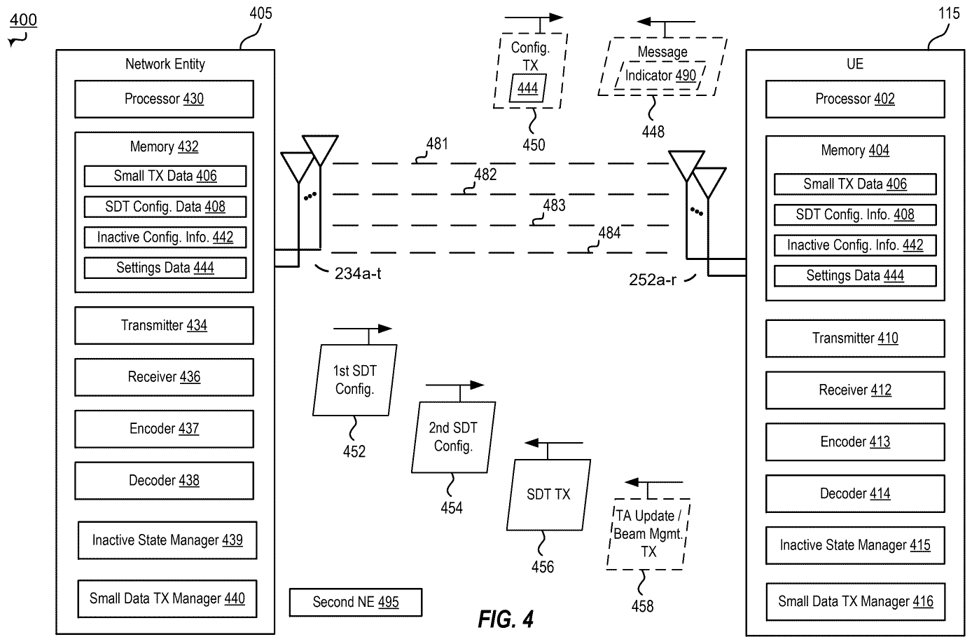

FIG. 4 illustrates an example of a wireless communications system 400 that supports enhanced small data transmission operations in accordance with aspects of the present disclosure. In some examples, wireless communications system 400 may implement aspects of wireless communication system 100. For example, wireless communications system 400 may include a network, such as one or more network entities (e.g., network entity 405 and second network entity 495), and one or more UEs, such as UE 115. As illustrated in the example of FIG. 4, each of the network entity 405 and the second network entity 495 may include or correspond to a base station, such as base station 105. Alternatively, a network entity may include or correspond to a different network device (e.g., not a base station). Enhanced small data transmission operations may reduce latency, power consumption, beam failures, and network overhead, and may enable improved capabilities in non-connected states (e.g., an RRC inactive state), such as cell selection or reselection and beam management operations. These improvements enhance the overall performance of the wireless communications system 400 and the experience of the user.

Network entity 405, second network entity 495, and UE 115 may be configured to communicate via one or more portions of the electromagnetic spectrum. The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “mmWave” band in documents and articles, despite being different from the extremely high frequency (EHF) band (30 GHz-300 GHz) which is identified by the International Telecommunications Union (ITU) as a “mmWave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

It is noted that SCS may be equal to 15, 30, 60, or 120 kHz for some data channels. Base station 105 and UE 115 may be configured to communicate via one or more component carriers (CCs), such as representative first CC 481, second CC 482, third CC 483, and fourth CC 484. Although four CCs are shown, this is for illustration only, more or fewer than four CCs may be used. One or more CCs may be used to communicate control channel transmissions, data channel transmissions, and/or sidelink channel transmissions.

Such transmissions may include a Physical Downlink Control Channel (PDCCH), a Physical Downlink Shared Channel (PDSCH), a Physical Uplink Control Channel (PUCCH), a Physical Uplink Shared Channel (PUSCH), a Physical Sidelink Control Channel (PSCCH), a Physical Sidelink Shared Channel (PSSCH), or a Physical Sidelink Feedback Channel (PSFCH). Such transmissions may be scheduled by aperiodic grants and/or periodic grants.

Each periodic grant may have a corresponding configuration, such as configuration parameters/settings. The periodic grant configuration may include configured grant (CG) configurations and settings. Additionally, or alternatively, one or more periodic grants (e.g., CGs thereof) may have or be assigned to a CC ID, such as intended CC ID.

Each CC may have a corresponding configuration, such as configuration parameters/settings. The configuration may include bandwidth, bandwidth part, HARQ process, TCI state, RS, control channel resources, data channel resources, or a combination thereof. Additionally, or alternatively, one or more CCs may have or be assigned to a Cell ID, or a Bandwidth Part (BWP) ID. The Cell ID may include a unique cell ID for the CC, a virtual Cell ID, or a particular Cell ID of a particular CC of the plurality of CCs. Additionally, or alternatively, one or more CCs may have or be assigned to a HARQ ID. Each CC may also have corresponding management functionalities, such as, beam management or BWP switching functionality. In some implementations, two or more CCs are quasi co-located, such that the CCs have the same beam and/or same symbol.

In some implementations, control information may be communicated via network entity 405, second network entity 495, and UE 115. For example, the control information may be communicated using MAC-CE transmissions, RRC transmissions, DCI (downlink control information) transmissions, UCI (uplink control information) transmissions, SCI (sidelink control information) transmissions, another transmission, or a combination thereof.

UE 115 can include a variety of components (e.g., structural, hardware components) used for carrying out one or more functions described herein. For example, these components can include processor 402, memory 404, transmitter 410, receiver 412, encoder, 413, decoder 414, inactive state manager 415, SDT manager 416, and antennas 252a-r. Processor 402 may be configured to execute instructions stored at memory 404 to perform the operations described herein. In some implementations, processor 402 includes or corresponds to controller/processor 280, and memory 404 includes or corresponds to memory 282. Memory 404 may also be configured to store small transmission data 406, SDT configuration information 408, inactive state configuration information 442, settings data 444, or a combination thereof, as further described herein.

The small transmission data 406 includes or corresponds to data that is associated with small data transmissions. The small transmission data 406 may include short and/or small bursts of data for MBB and IoT applications, such as data for instant messaging application, social media applications, wearable devices (e.g., fitness trackers and monitors), etc. The small transmission data 406 may include data with less than a threshold number of bytes, such as less than 10 bytes or less than 32000 bytes.

The SDT configuration information 408 includes or corresponds to data associated with or corresponding to SDT operations configuration information. For example, the SDT configuration information 408 may indicate SDT configurations for multiple cells. To illustrate, the SDT configuration information 408 may include multiple per cell SDT configuration or information elements, each having a corresponding cell, or may include a single SDT confirmation or information element specifying a joint SDT configuration for multiple cells of a cell group.

The inactive state configuration information 442 includes or corresponds to data associated with or corresponding to configuration information for inactive state operations to support or enhance the enhanced and flexible SDT operations described herein. For example, the inactive state configuration information 442 may indicate inactive state configurations for multiple cells and to perform beam management operations, cell selection operations, and UL synchronization operations form an RRC inactive state. The inactive state configuration information 442 may be a part of or separate from the SDT configuration information 408. Similar to the SDT configuration information 408, the inactive state configuration information 442 may be receive from a single cell or from multiple cells and each configuration may apply to a single cell or to multiple cells of a group.

The settings data 444 includes or corresponds to data associated with enhanced SDT transmissions operations. The settings data 444 may include one or more types of enhanced SDT transmission operation modes and/or thresholds or conditions for switching between enhanced SDT transmission modes and/or configurations. For example, the settings data 444 may have data indicating different thresholds for different enhanced SDT transmission modes, such as CG-based, RA-based, etc.

Transmitter 410 is configured to transmit data to one or more other devices, and receiver 412 is configured to receive data from one or more other devices. For example, transmitter 410 may transmit data, and receiver 412 may receive data, via a network, such as a wired network, a wireless network, or a combination thereof. For example, UE 115 may be configured to transmit and/or receive data via a direct device-to-device connection, a local area network (LAN), a wide area network (WAN), a modem-to-modem connection, the Internet, intranet, extranet, cable transmission system, cellular communication network, any combination of the above, or any other communications network now known or later developed within which permits two or more electronic devices to communicate. In some implementations, transmitter 410 and receiver 412 may be replaced with a transceiver. Additionally, or alternatively, transmitter 410 or receiver, 412 may include or correspond to one or more components of UE 115 described with reference to FIG. 2.

Encoder 413 and decoder 414 may be configured to encode and decode data for transmission. The inactive state manager 415 may be configured to determine and perform inactive state operations, such as inactive state operations to support SDT operations. For example, the inactive state manager 415 is configured to perform cell selection/reselection operations, beam management operations, UL synchronization operations, or a combination thereof. The cell selection/reselection operations may include determination and evaluation of trigger conditions for performing selection/reselection operations, and the evaluation and selection of a new cell. The beam management operations may include determination and evaluation of trigger conditions for beam management operations, and the evaluation and selection of a new beam. The UL synchronization operations may include determination and evaluation of trigger conditions for performing early UL synchronization update operations, and the performance of the early UL synchronization update operations.

The SDT manager 416 may be configured to determine and perform small data transmission management operations. For example, small data transmission manager 416 may be configured to determine data for small data transmissions and to generate small data transmissions. As another example, the SDT manager 416 is configured to perform SDT operations with SDT configurations for multiple cells. To illustrate, the SDT manager 416 may determine which SDT configurations to obtain, store, use and/or release. In addition, the SDT manager 416 may be configured to perform reporting operations for SDT operations, such as to generate reports for SDT beam management. As yet another example, the SDT manager 416 is configured to perform SDT operations with multiple data subscriptions. To illustrate, the SDT manager 416 may determine which data subscription or subscriptions to select for SDT operations.

Network entity 405 (e.g., base station 105) includes processor 430, memory 432, transmitter 434, receiver 436, encoder 437, decoder 438, inactive state manager 439, SDT manager 440, and antennas 234a-t. Processor 430 may be configured to execute instructions stores at memory 432 to perform the operations described herein. In some implementations, processor 430 includes or corresponds to controller/processor 240, and memory 432 includes or corresponds to memory 242. Memory 432 may be configured to store small transmission data 406, SDT configuration information 408, inactive state configuration information 442, settings data 444, or a combination thereof, similar to the UE 115 and as further described herein.

Transmitter 434 is configured to transmit data to one or more other devices, and receiver 436 is configured to receive data from one or more other devices. For example, transmitter 434 may transmit data, and receiver 436 may receive data, via a network, such as a wired network, a wireless network, or a combination thereof. For example, UEs and/or base station 105 may be configured to transmit and/or receive data via a direct device-to-device connection, a local area network (LAN), a wide area network (WAN), a modem-to-modem connection, the Internet, intranet, extranet, cable transmission system, cellular communication network, any combination of the above, or any other communications network now known or later developed within which permits two or more electronic devices to communicate. In some implementations, transmitter 434 and receiver 436 may be replaced with a transceiver. Additionally, or alternatively, transmitter 434 or receiver, 436 may include or correspond to one or more components of UE 115 described with reference to FIG. 2.

Encoder 437, and decoder 438 may include the same functionality as described with reference to encoder 413 and decoder 414, respectively. Inactive state manager 439 may include similar functionality as described with reference to inactive state manager 415. SDT manager 440 may include similar functionality as described with reference to SDT manager 416.

The second network entity 495 may include one or more elements similar to the network entity 405. The network entity 405 and the second network entity 495 may be connected to each other via a network or backhaul connection and may coordinate SDT configuration information settings and signaling settings for the SDT configuration information.

During operation of wireless communications system 400, network entity 405 may determine that UE 115 has enhanced SDT capabilities, such as CG-based SDT operation capabilities with candidate cells. For example, UE 115 may transmit a message 448 that includes a SDT configuration indicator 490 (e.g., a per cell SDT transmission indicator). Indicator 490 may indicate CG-based SDT operation capabilities for candidate cells or a particular type or mode of CG-based SDT operation capabilities for candidate cells (e.g., the ability to store per-cell SDT configuration information or multiple cell SDT configuration information). In some implementations, network entity 405 sends control information to indicate to UE 115 that CG-based SDT operation capabilities for candidate cells and/or a particular type of CG-based SDT operation capabilities for candidate cells is to be used. For example, in some implementations, message 448 (or another message, such as configuration transmission 450) is transmitted by the network entity 405. The configuration transmission 450 may include or indicate to use CG-based SDT operation capabilities for candidate cells or to adjust or implement a setting of a particular type of CG-based SDT operation capabilities for candidate cells.

During enhanced SDT operation, devices of wireless communications system 400 perform transmission of small data to any candidate cell that the device has a valid SDT configuration for. For example, the network and the UE 115 may exchange transmissions to set a particular SDT configuration. Such transmissions may include or correspond to SIB messages or RRC transmissions. In the example of FIG. 4, the UE 115 receives a first SDT configuration 452 and a second SDT configuration 454. The first SDT configuration 452 and the second SDT configuration 454 may be received in a single transmission or in multiple transmissions. Additionally, or alternatively, the first SDT configuration 452 and the second SDT configuration 454 may be received from a single cell or from multiples cells. For example, the network entity 405, the second network entity 495, or both, transmit a SDT configuration transmission with their own corresponding per cell SDT configuration information. As another example, one of the cells, such as the network entity 405, may transmit a SDT configuration transmission with a group SDT configuration for multiple cells (e.g., including the first SDT configuration 452 and the second SDT configuration 454) or with the first SDT configuration 452 and the second SDT configuration 454. In some other examples, a single cell, such as the network entity 405, may transmit the first SDT configuration 452 and the second SDT configuration 454 via different transmissions and/or different mechanisms.

To illustrate, the network entity 405 may transmit its own SDT configuration via a SIB message and may transmit other neighbor or group cell SDT configuration (and optionally along with its own SDT configuration) in a RRC release message with suspend configuration information that includes the SDT configuration information for multiple cells, such as group cell SDT configuration infraction or multiple per cell SDT configurations.

The UE 115 may perform enhanced SDT transmission operations, such as flexible transmission of small data to one or more candidate cells, based on the received SDT configuration information for multiple cells. For example, the UE 115 may determine to switch cells, such as from the network entity 405 to the second network entity 495, and transmit one or more SDT transmissions responsive to a SDT transmit condition being satisfied, such as SDT transmission 456. The SDT transmission 456 may include or correspond to a first SDT transmission after receiving the SDT configurations 452 and/or 454, such as an SDT transmission sent while in an inactive mode or unconnected mode (e.g., RRC INACTIVE). The SDT transmission 456 may include or correspond to a CG-based SDT or a RA-based SDT as described with reference to FIG. 3A or FIG. 3B. For example, the UE 115 may utilize a CG to request a direct grant or perform a RACH operation to perform the SDT transmission 456.

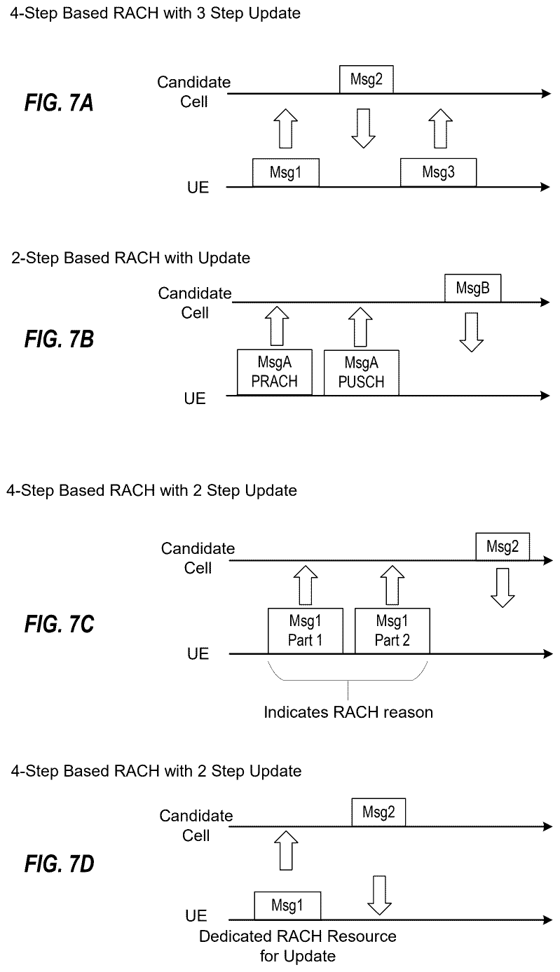

While the SDT configurations 452 and/or 454 are valid, the UE 115 may perform uplink synchronization operations to update or extend the corresponding TA timer or TA timers for the SDT configurations 452 and/or 454, as described further with reference to FIGS. 7A-7D. Additionally, or alternatively, the UE 115 may perform beam management operations, such as beam management transmission 458, for the SDT configurations 452 and/or 454 to manage (e.g., switch) beams used to transmit SDTs, such as the SDT transmission 456.

Accordingly, the UE 115 and network entity 405 may be able to more efficiently perform small data transmissions by utilizing multiple or per cell SDT configurations to enable SDT operations for mobility scenarios. Thus, FIG. 4 describes enhanced transmission of small data operations for inactive modes. Performing enhanced transmission of small data operations enables reduced network overhead and signaling when performing small data transmissions and thus, enhanced UE and network performance by increasing throughput and reducing latency for other devices and the network as a whole.

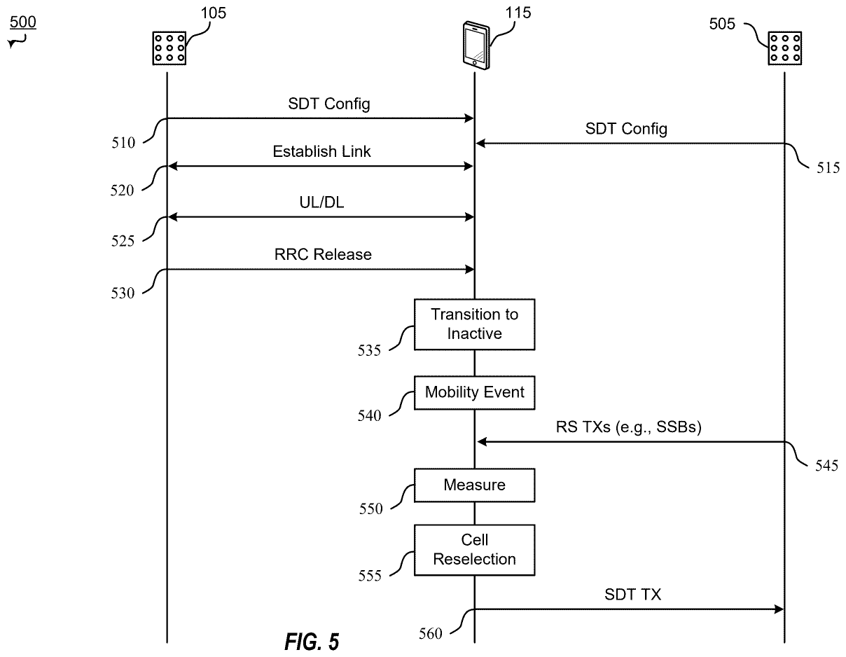

Referring to FIG. 5, FIG. 5 is a timing diagram 500 illustrating a wireless communication system that supports enhanced small data transmissions according to one or more aspects. The example of FIG. 5 corresponds to an example of enhanced small data transmissions for mobility operations where SDT configuration information is provided by each cell.

The example of FIG. 5 includes similar devices to the devices described in FIGS. 1, 2, and 4, such as a UE 115, a network entity (e.g., base station 105), and a second network entity (e.g., second base station 505). The devices of FIG. 5 may include one or more of the components as described in FIGS. 2 and 4. In FIG. 5, these devices may utilize antennas 252a-r, transmitter 410, receiver 412, encoder 413 and/or decoder 414, or may utilize antennas 234a-t, transmitter 434, receiver 436, encoder 437 and/or decoder 438 to communicate and receive transmissions. In some implementations, the network entity may include or correspond to multiple TRPs of a single base station (e.g., base station 105), to multiple base stations, or any combination thereof.

At 510, the base station 105 transmits small data transmission configuration information to the UE 115. For example, the base station 105 may transmit a SDT configuration message to the UE 115 including SDT configuration information for the base station 105 and optionally for one or more other candidate cells, such as the second base station 505. The SDT configuration message may include or correspond to a unicast transmission or a broadcast transmission. For example, the SDT configuration message may correspond to or be part of a SIB message, such as a SIB1-SIB9 transmission. As another example, the SDT configuration message may include or correspond to a DL transmission, such as PDSCH, that includes the SDT configuration information for the UE 115.

At 515, the second base station 505 optionally transmits second small data transmission configuration information to the UE 115. For example, the second base station 505 may transmit a second SDT configuration message to the UE 115 including second SDT configuration information for the second base station 505 and optionally for one or more other candidate cells, such as the base station 105 and/or other base stations. The second SDT configuration message may include or correspond to a unicast transmission or a broadcast transmission. For example, the second SDT configuration message may correspond to or be part of a SIB message, such as a SIB1-SIB9 transmission. As another example, the second SDT configuration message may include or correspond to a DL transmission, such as PDSCH, that includes the second SDT configuration information for the UE 115.

At 520, the base station 105 and the UE 115 establish a Uu communication link (also referred to as Uu link or UL/DL link). For example, the UE 115 may perform RRC, RACH, and/or connection establishment operations to establish (or re-establish) an uplink and downlink communication link with a node of a network, such as base station 105. In some implementations, the communication link may be established as part of a handover operation or through another UE. As illustrated in the example of FIG. 5, the base station 105 and UE 115 may communicate higher layer signaling, such as RRC signaling (e.g., a RRC transmission or message) or control layer signaling, to establish the connection and link.

After establishing the Uu communication link, the base station 105 and the UE 115 may communicate or exchange transmissions at 525. For example, the UE 115 may receive downlink transmissions from the base station 105 and/or transmit uplink transmissions to the base station 105, such as to communicate data. Although such operations are indicated after reception of the SDT configurations, the connection and UL/DL operations may occur prior to reception of the SDT configurations, or both prior to and after reception of the SDT configurations.

At 530, the base station 105 performs a RRC release operation for the UE 115. For example, the base station 105 transmits a RRC release message to the UE 115. In some implementations, the RRC release message may include or correspond to a SDT configuration message and may include SDT configuration information for the base station 105 and optionally for one or more other candidate cells, such as the second base station 505. For example, the RRC release message may include a suspend configuration (e.g., suspend configuration information, such as Suspend-config).

The RRC release message may include or correspond to a unicast transmission. For example, the RRC release message may include or correspond to a DL transmission, such as PDSCH, that includes the SDT configuration information for the UE 115. The SDT configuration information may be included in a RRC suspend configuration message or information element, such as RRC Suspend Config. The RRC release operation may occur or be triggered by any potential cause, such as a mobility event, a failure, device inactivity, a power saving mode, etc.

At 535, the UE 115 transitions to an inactive or idle state. For example, the UE 115 may transition from a connected or higher power or activity RRC state to a lower power or activity RRC state or a non-connected RRC state based on or responsive to receiving the RRC release transmission from the base station 105. To illustrate, the UE 115 may transition from a RRC connected state to an RRC inactive state. As another illustration, the UE 115 may transition from a RRC connected state or RRC inactive state to an RRC idle state.

At 540, the UE 115 determines a mobility event. For example, the UE 115 may determine to engage in cell selection/reselection operations (e.g., measurement operations, evaluation of candidate cell operations, handover operations, etc.) based on determining that a mobility event trigger condition has been satisfied, or that multiple such conditions have been satisfied. As illustrative, non-limiting examples of mobility event trigger conditions, a mobility event trigger condition may include one or more of a device movement condition (e.g., inertial sensors), a on network settings condition (e.g., expiration of a TA timer), an error or failures condition (e.g., no longer receiving broadcast or unicast transmissions from the base station 105, BLER rate, signal strength, etc.), a handover condition, or a mobility trigger condition (e.g., a threshold amount of movement, movement out of a defined area or cell, etc.).

At 545, the second base station 505 may transmit reference signal information to the UE 115. For example, the base station 105 may transmit one or more reference signal transmission to the UE 115 for measurement by the UE 115. To illustrate, the base station 105 may transmit (e.g., broadcast) one or more SSB transmissions using different beams for measurement by the UE 115, and optionally one or more other UEs. Although not shown in FIG. 5, the base station 105 may also transmit reference signal transmissions which may be received and/or measured by the UE 115.

At 550, the UE 115 measures the reference signal information. For example, the UE 115 may monitor for and receive the reference signal transmissions from the second base station 505, and the UE 115 generates measurement information based on receiving and measuring the reference signal transmissions from the second base station 505. The UE 115 may then determine to switch cells based on the measurement information. Additionally, or alternatively, the UE 115 may monitor for and receive second reference signal transmissions from the base station 105, and may determine to switch cells based on second measurement information corresponding to the second reference signal transmissions from the base station 105.

In some aspects where the UE 115 has experienced a mobility event or where a connection to a particular cell degrades (e.g., due to blockage or interference), the UE 115 may determine to switch cells. To illustrate, the UE 115 determines to switch cells based on determining that a mobility event trigger conditions has been satisfied, or that multiple conditions have been satisfied in the example of FIG. 5. As illustrative, non-limiting examples of mobility event trigger conditions, a mobility event trigger condition may include one or more of a device movement condition (e.g., inertial sensors), a on network settings condition (e.g., expiration of a TA timer), an error or failures condition (e.g., no longer receiving broadcast or unicast transmissions from the base station 105, BLER rate, signal strength, etc.), a handover condition, or a mobility trigger condition (e.g., a threshold amount of movement, movement out of a defined area or cell, etc.).

At 555, the UE 115 performs a cell selection operation. For example, the UE 115 may perform cell selection and/or evaluation operations responsive to determining to switch cells based on a determination that a cell selection/reselection condition has been satisfied (e.g., a mobility event trigger condition), or that multiple such conditions have been satisfied. The cell selection operations and/or condition may include or be based in part on the reference signal measurement information, such as the reference signal measurement information for the second base station 505 exceeding a threshold amount and/or from second reference signal measurement information from the base station 105 being less than the threshold amount or a second threshold amount.

At 560, the UE 115 performs a small data transmission operation to transmit small data (e.g., a first SDT) to the second base station 505. For example, the UE 115 may perform a CG-based SDT operation or a RACH-based SDT operation similar to operations as described with reference to FIG. 3A or FIG. 3B based on the SDT configuration information received from the base station 105 or based on the second SDT configuration information received from the second base station 505 (which was received while or prior to the UE 115 being connected to the base station 105 and possibly while the second base station was only a candidate cell).

As compared to the operations in FIGS. 3A and 3B, in the example of FIG. 5 the UE 115 performs a small data transmission with a candidate cell (e.g., second base station 505) and not its last serving cell or cell that it was camped on or connected to, such as the base station 105 which was last cell the UE 115 was in a RRC connected mode with. This enables the UE 115 to change cells for performance reasons and/or move around throughout the network to nearby cells and still perform SDT operations with such other nearby cells without reconnecting to the network to get updated SDT configuration information for the other nearby cells. In some such examples, the small data transmission is a CG-based SDT, and in other examples the small data transmission is a RA-based SDT.

As an example of CG-based SDT operation, the UE 115 may utilize a configured grant to transmit an uplink transmission, such as a PUSCH or PUCCH transmission, to the second base station 505 that includes a RRC resume request. The second base station 505 may respond with a signaling or scheduling message (e.g., DCI or PDCCH transmission) indicating a direct grant for a SDT based on and/or in response to the RRC resume request in the configured grant. The UE 115 may transmit or receive a SDT during the direct grant indicated by the second base station 505. Additionally, the UE 115 and the second base station 505 may exchange additional SDTs during the session (e.g., while the configured grant is active and/or while the TA timer is valid and not expired) and while the UE 115 is not connected, such as not in the RRC Connected state and while in an RRC Inactive state.

As an example of RACH-based SDT operation, the UE 115 may utilize a RACH procedure, such as 2-Step or 4-Step RACH operation, to transmit a SDT. To illustrate, the UE 115 may transmit a RACH request (e.g., a RACH preamble or Msg1) to the second base station 105 to begin a 4-Step RACH procedure. The second base station 505 receives the RACH request and transmits a RACH response (e.g., RAR) to the UE 115. The UE 115 receives the RACH response and transmits a RRC resume request or Msg3 to the second base station 505. The second base station 505 may respond with a contention resolution message to end or complete the 4-Step RACH procedure. The second base station 505 may provide a signaling or scheduling message (e.g., DCI or PDCCH transmission) indicating a direct grant for a SDT to the UE 115 in the contention resolution message or in a separate transmission (e.g., a subsequent DCI or PDCCH transmission). The UE 115 may then transmit or receive a SDT during the signaled grant and/or based on the contention resolution message. Additionally, the UE 115 and the second base station 505 may exchange additional SDTs after the RACH procedure and while the UE 115 is not connected, such as not in the RRC Connected state and while in an RRC Inactive state.

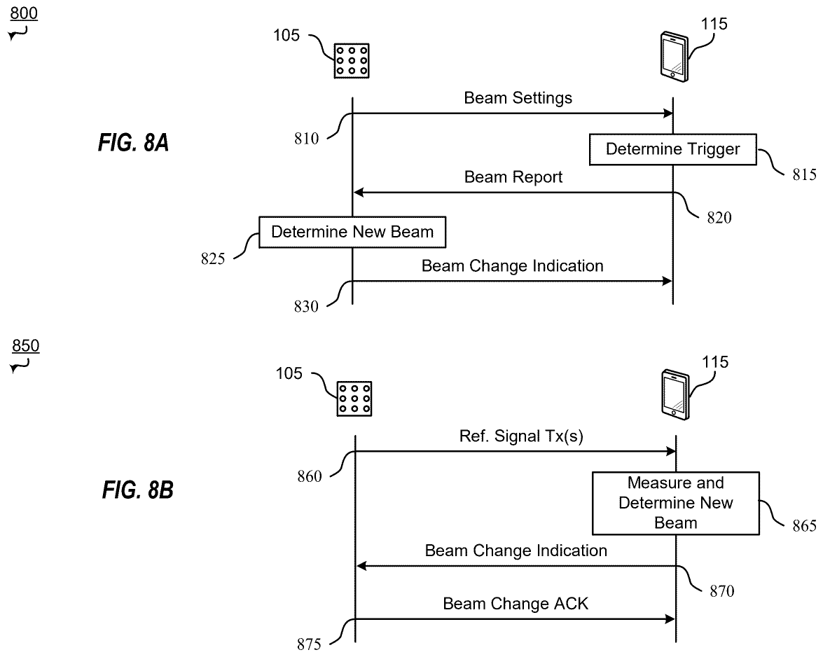

Optionally, the devices may perform additional enhanced beam management and mobility operations in an inactive state and/or for the enhanced SDT operations. For example, the network or the base station may engage in early timer update and/or RACH synchronization operations as described further with reference to FIGS. 7A-7D to further support or improved the enhanced SDT operations. As another example, the network or the base station may engage in beam management and switching operations as described further with reference to FIGS. 8A and 8B to further support or improved the enhanced SDT operations.

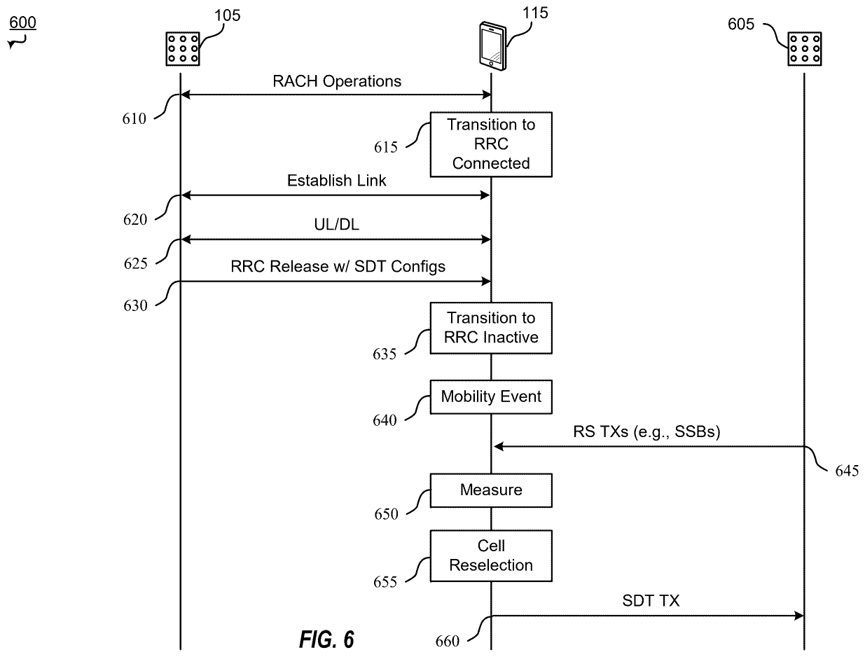

Referring to FIG. 6, FIG. 6 is a timing diagram 600 illustrating a wireless communication system that supports enhanced small data transmissions according to one or more aspects. The example of FIG. 6 corresponds to an example of enhanced small data transmissions for mobility operations where SDT configuration information for multiple cells is provided by one cell, such as the serving or primary cell.

The example of FIG. 6 includes similar devices to the devices described in FIGS. 1, 2, 4, and 5, such as a UE 115 (e.g., a first UE), a network entity (e.g., base station 105), and a second network entity (e.g., second base station 605). The devices of FIG. 6 may include one or more of the components as described in FIGS. 2 and 4. In FIG. 6, these devices may utilize antennas 252a-r, transmitter 410, receiver 412, encoder 413 and/or decoder 414, or may utilize antennas 234a-t, transmitter 434, receiver 436, encoder 437 and/or decoder 438 to communicate and receive transmissions. In some implementations, the network entity may include or correspond to multiple TRPs of a single base station (e.g., base station 105), to multiple base stations, or any combination thereof.

### XX

At 610, the base station 105 and the UE 115 perform RACH operations. For example, the UE 115 and the base station 105 perform 2 or 4-Step RACH operations for the purpose of connecting to the network and as described herein and/or known in the art. During the RACH operations and/or prior to the RACH operations, such as by SIB messaging, the UE 115 may receive SDT configuration information. The SDT configuration information may include an SDT configuration for only the base station 105, a single SDT configuration for a group of base stations that include the base station 105, and optionally the second base station 105, or multiple per cell SDT configurations for the base station 105 and the second base station 605.

At 615, the UE 115 may transition to an RRC CONNECTED from an RRC IDLE or INACTIVE mode. For example, the UE 115 may receive the contention resolution message and determine to switch to a RRC CONNECTED mode from a RRC IDLE or INACTIVE mode.

At 620, the base station 105 and the UE 115 establish a Uu communication link (also referred to as Uu link or UL/DL link). For example, the UE 115 may perform RRC, RACH, and/or connection establishment operations to establish (or re-establish) an uplink and downlink communication link with a node of a network, such as base station 105. In some implementations, the communication link may be established as part of a handover operation or through another UE. As illustrated in the example of FIG. 6, the base station 105 and UE 115 may communicate higher layer signaling, such as RRC signaling (e.g., a RRC transmission or message) or control layer signaling, to establish the connection and link.

After establishing the Uu communication link, the base station 105 and the UE 115 may communicate or exchange transmissions at 625. For example, the UE 115 may receive downlink transmissions from the base station 105 and/or transmit uplink transmissions to the base station 105, such as to communicate data. Although such operations are indicated after reception of the SDT configurations, the connection and UL/DL operations may occur prior to reception of the SDT configurations, or both prior to and after reception of the SDT configurations.

At 630, the base station 105 performs a RRC release operation for the UE 115. For example, the base station 105 transmits a RRC release message to the UE 115. In some implementations, the RRC release message may include or correspond to a SDT configuration message and may include SDT configuration information for the base station 105 and optionally for one or more other candidate cells, such as the second base station 605. For example, the RRC release message may include a suspend configuration (e.g., suspend configuration information, such as Suspend-config) that includes a single SDT configuration for multiple base stations or cells or that include multiple per cell/per base station SDT configurations for multiple cells, including at least the base station 105 and second base station 605.

The RRC release message may include or correspond to a unicast transmission. For example, the RRC release message may include or correspond to a DL transmission, such as PDSCH, that includes the SDT configuration information for the UE 115. The SDT configuration information may be included in a RRC suspend configuration message or information element, such as RRC Suspend Config. The RRC release operation may occur or be triggered by any potential cause, such as a mobility event, a failure, device inactivity, a power saving mode, etc.

At 635, the UE 115 transitions to an inactive or idle state. For example, the UE 115 may transition from a connected or higher power or activity RRC state to a lower power or activity RRC state or a non-connected RRC state based on or responsive to receiving the RRC release transmission from the base station 105. To illustrate, the UE 115 may transition from a RRC connected state to an RRC inactive state. As another illustration, the UE 115 may transition from a RRC connected state or RRC inactive state to an RRC idle state.

At 640, the UE 115 determines a mobility event. For example, the UE 115 may determine to engage in cell selection/reselection operations (e.g., measurement operations, evaluation of candidate cell operations, handover operations, etc.) based on determining that a mobility event trigger condition has been satisfied, or that multiple such conditions have been satisfied. As illustrative, non-limiting examples of mobility event trigger conditions, a mobility event trigger condition may include one or more of a device movement condition (e.g., inertial sensors), a on network settings condition (e.g., expiration of a TA timer), an error or failures condition (e.g., no longer receiving broadcast or unicast transmissions from the base station 105, BLER rate, signal strength, etc.), a handover condition, or a mobility trigger condition (e.g., a threshold amount of movement, movement out of a defined area or cell, etc.).

At 645, the second base station 605 may transmit reference signal information to the UE 115. For example, the base station 105 may transmit one or more reference signal transmission to the UE 115 for measurement by the UE 115. To illustrate, the base station 105 may transmit (e.g., broadcast) one or more SSB transmissions using different beams for measurement by the UE 115, and optionally one or more other UEs. Although not shown in FIG. 6, the base station 105 may also transmit reference signal transmissions which may be received and/or measured by the UE 115.

At 650, the UE 115 measures the reference signal information. For example, the UE 115 may monitor for and receive the reference signal transmissions from the second base station 605, and the UE 115 generates measurement information based on receiving and measuring the reference signal transmissions from the second base station 605. The UE 115 may then determine to switch cells based on the measurement information. Additionally, or alternatively, the UE 115 may monitor for and receive second reference signal transmissions from the base station 105, and may determine to switch cells based on second measurement information corresponding to the second reference signal transmissions from the base station 105.

In some aspects where the UE 115 has experienced a mobility event or where a connection to a particular cell degrades (e.g., due to blockage or interference), the UE 115 may determine to switch cells. To illustrate, the UE 115 determines to switch cells based on determining that a mobility event trigger conditions has been satisfied, or that multiple conditions have been satisfied in the example of FIG. 6. As illustrative, non-limiting examples of mobility event trigger conditions, a mobility event trigger condition may include one or more of a device movement condition (e.g., inertial sensors), a on network settings condition (e.g., expiration of a TA timer), an error or failures condition (e.g., no longer receiving broadcast or unicast transmissions from the base station 105, BLER rate, signal strength, etc.), a handover condition, or a mobility trigger condition (e.g., a threshold amount of movement, movement out of a defined area or cell, etc.).

At 655, the UE 115 performs a cell selection operation. For example, the UE 115 may perform cell selection and/or evaluation operations responsive to determining to switch cells based on a determination that a cell selection/reselection condition has been satisfied (e.g., a mobility event trigger condition), or that multiple such conditions have been satisfied. The cell selection operations and/or condition may include or be based in part on the reference signal measurement information, such as the reference signal measurement information for the second base station 605 exceeding a threshold amount and/or from second reference signal measurement information from the base station 105 being less than the threshold amount or a second threshold amount.

At 660, the UE 115 performs a small data transmission operation to transmit small data (e.g., a first SDT) to the second base station 605. For example, the UE 115 may perform a CG-based SDT operation or a RACH-based SDT operation similar to operations as described with reference to FIG. 3A or FIG. 3B based on the SDT configuration information received from the base station 105 and for the second base station 605.

As compared to the operations in FIGS. 3A and 3B, in the example of FIG. 6 the UE 115 performs a small data transmission with a candidate cell (e.g., second base station 605) and not its last serving cell or cell that it was camped on or connected to, such as the base station 105 which was last cell the UE 115 was in a RRC connected mode with. This enables the UE 115 to change cells for performance reasons and/or move around throughout the network to nearby cells and still perform SDT operations with such other nearby cells without reconnecting to the network to get updated SDT configuration information for the other nearby cells. In some such examples, the small data transmission is a CG-based SDT, and in other examples the small data transmission is a RA-based SDT.

As an example of CG-based SDT operation, the UE 115 may utilize a configured grant to transmit an uplink transmission, such as a PUSCH or PUCCH transmission, to the second base station 605 that includes a RRC resume request. The second base station 605 may respond with a signaling or scheduling message (e.g., DCI or PDCCH transmission) indicating a direct grant for a SDT based on and/or in response to the RRC resume request in the configured grant. The UE 115 may transmit or receive a SDT during the direct grant indicated by the second base station 605. Additionally, the UE 115 and the second base station 605 may exchange additional SDTs during the session (e.g., while the configured grant is active and/or while the TA timer is valid and not expired) and while the UE 115 is not connected, such as not in the RRC Connected state and while in an RRC Inactive state.

As an example of RACH-based SDT operation, the UE 115 may utilize a RACH procedure, such as 2-Step or 4-Step RACH operation, to transmit a SDT. To illustrate, the UE 115 may transmit a RACH request (e.g., a RACH preamble or Msg1) to the second base station 105 to begin a 4-Step RACH procedure. The second base station 605 receives the RACH request and transmits a RACH response (e.g., RAR) to the UE 115. The UE 115 receives the RACH response and transmits a RRC resume request or Msg3 to the second base station 605. The second base station 605 may respond with a contention resolution message to end or complete the 4-Step RACH procedure. The second base station 605 may provide a signaling or scheduling message (e.g., DCI or PDCCH transmission) indicating a direct grant for a SDT to the UE 115 in the contention resolution message or in a separate transmission (e.g., a subsequent DCI or PDCCH transmission). The UE 115 may then transmit or receive a SDT during the signaled grant and/or based on the contention resolution message. Additionally, the UE 115 and the second base station 605 may exchange additional SDTs after the RACH procedure and while the UE 115 is not connected, such as not in the RRC Connected state and while in an RRC Inactive state.

Optionally, the devices may perform additional enhanced beam management and mobility operations in an inactive state and/or for the enhanced SDT operations. For example, the network or the base station may engage in early timer update and/or RACH synchronization operations as described further with reference to FIGS. 7A-7D to further support or improved the enhanced SDT operations. As another example, the network or the base station may engage in beam management and switching operations as described further with reference to FIGS. 8A and 8B to further support or improved the enhanced SDT operations.

Referring to FIGS. 7A-7D, each of FIGS. 7A-7D illustrate a timing diagram depicting an example of enhanced synchronization operations for the enhanced SDT operations described herein. The examples of FIGS. 7A-7D correspond to examples of early UL synchronization operations to support the enhanced SDT operations described herein. For example, the early UL synchronization operations may enable renewal and extension of timers utilized or impacting SDT operations, such as a TA timer and other related timers.

FIGS. 7A and 7C each correspond to examples of UL synchronization operations for 4-Step RACH operations, FIG. 7B corresponds to an examples of UL synchronization operations for 2-Step RACH operations, and FIG. 7D corresponds to example of UL synchronization operations for either 2-Step or 4-Step RACH operations, but a depiction of the 4-Step RACH version is illustrated in FIG. 7D.

In the examples of FIGS. 7A and 7B, the synchronization operations may be performed based on RACH configuration information (e.g., RACH configurations for SDT operations in RACH or SDT configuration information) provided previously by the network, such as upon initial connection via system information messages and/or RRC configuration. For example, the RACH configuration may include dedicated SDT configurations that enable a UE to initiate a RACH operation with an initial message (e.g., Msg1 or MsgA) and that enable the network to provide the updated synchronization information in the subsequent response message (e.g., Msg2 or MsgB). The UE may include the RACH reason for early UL sync in Msg3 or MsgA PUSCH to indicate completion of the RACH procedure for synchronization purposes as opposed to other conventional RACH purposes (e.g., reconnection, failure recovery, handover, etc.).

With reference to the timing diagram in FIG. 7A, during operation the UE 115 begins a 4-step RACH operation and transmits a RACH request or Msg1 to the candidate cell (e.g., base station 105 or network entity 405, 495). The RACH operation may be performed responsive to the UE 115 determining that a timer (e.g., TA timer) associated with its SDT configuration for the candidate cell is about to expire.

The candidate cell responds to the RACH request or Msg1 by transmitting a RACH response or Msg2 to the UE 115. The RACH response or Msg2 may include updated timing information or updated SDT configuration information that the UE 115 can use to update its timer and/or SDT configuration and perform an early synchronization operation before expiration of the timer and/or SDT configuration.

The UE 115 may optionally respond to the candidate cell with a Msg3 to indicate to the network and candidate cell that the rationale or purpose for the RACH operations was for the early synchronization operation. This indication to the cell and network may help the network to end the RACH operation and refrain from performing other RACH operations or post RACH operations that are not needed for uplink synchronization.

With reference to the timing diagram in FIG. 7B, during operation the UE 115 begins a 2-step RACH operation and transmits a RACH request or MsgA to the candidate cell (e.g., base station 105 or network entity 405, 495). The RACH operation may be performed responsive to the UE 115 determining that a timer (e.g., TA timer) associated with its SDT configuration for the candidate cell is about to expire.

The candidate cell responds to the RACH request or MsgA by transmitting a RACH response or MsgB to the UE 115. The RACH response or MsgB may include updated timing information or updated SDT configuration information that the UE 115 can use to update its timer and/or SDT configuration and perform an early synchronization operation before expiration of the timer and/or SDT configuration.

In the example of FIG. 7B, transmission of the MsgB completes the RACH operation. In some examples, the UE 115 may include the indication of the purpose of the RACH operation for early synchronization in either portion of the MsgA, that is either in the PRACH or the PUSCH. This indication may also cause the network to end the RACH operation and refrain from performing other post RACH operations that are not needed for uplink synchronization.

In the example of FIG. 7C, the initial message of the 4-Step RACH process, Msg1, may include two parts which can be used to indicate the RACH process is for UE synchronization, such as early UL synchronization. For example, the RACH request, Msg1, may include two preambles and one or both preambles may indicate the RACH reason is for early UL sync. The UL synchronization information is provided by the network in the RACH response, Msg2, to the RACH request, which completes the RACH procedure. As compared to the 4-Step RACH synchronization operations in FIG. 7A, including a RACH indication for synchronization or SDT operations in the first message or RACH request enables a shorter synchronization process and may eliminate the need for a third message, Msg3 or reduce subsequent network side operations. Using a two-part Msg1 to indicate SDT synchronization operations (e.g., early UL/TA timer synchronization or update) may leverage or expand on the previous proposals for a RACH enhancement proposed for 6G networks of a two-part RACH request.

With reference to the timing diagram in FIG. 7C, during operation the UE 115 begins a 4-step RACH operation and transmits a RACH request or Msg1 to the candidate cell (e.g., base station 105 or network entity 405, 495). The RACH operation may be performed responsive to the UE 115 determining that a timer (e.g., TA timer) associated with its SDT configuration for the candidate cell is about to expire. In the example of FIG. 7C, the Msg1 may have a 2 part format, i.e., include a part 1 and a part 2.

The candidate cell responds to the RACH request or Msg1 by transmitting a RACH response or Msg2 to the UE 115. The RACH response or Msg2 may include updated timing information or updated SDT configuration information that the UE 115 can use to update its timer and/or SDT configuration and perform an early synchronization operation before expiration of the timer and/or SDT configuration.

In the example of FIG. 7C, the UE 115 may not need to respond to the candidate cell with a Msg3 to indicate to the network and candidate cell that the rationale or purpose for the RACH operations was for the early synchronization operation. Rather, in the example FIG. 7C, the UE 115 uses the 2-part Msg1 structure to indicate to the cell and network the RACH operation is for early uplink synchronization. For example, the UE 115 can use part 1, part 2, or parts 1 and 2 to provide the indication or reason for the RACH operation to the candidate cell and network.

In the example of FIG. 7D, the initial message of a 2 or 4-Step RACH process, Msg1 or MsgA, is transmitted on a RACH resource dedicated to early UL synchronization operations or SDT synchronization operations. For example, the RACH resource configuration information (or the SDT configuration information) may be modified to include additional dedicated or reserved resources for synchronization operations, apart from general RACH resources (e.g., standard contention-based and contention-free RACH resources). The UL synchronization information (e.g., updated TA timer information) is provided by the network in an initial response message (e.g., second message of Msg2 or MsgB), which completes the RACH procedure. Use of the dedicated resource for synchronization operations indicates or otherwise signals that UL synchronization is needed for SDT operations as opposed to for transitioning to a RRC connected mode, and enables the network to provide the UL synchronization information in a second message and to optionally end the RACH process early, such as for the 4-Step RACH process. The early UL synchronization or SDT synchronization RACH configuration may include dedicated RACH resources that include reserved preamble(s) and/or reserved RACH occasion(s). As compared to the prior examples, the example of FIG. 7D may not need a separate indication in the Msg1 or MsgA itself, and may not need a change or extension to existing RACH message format. Instead, the use of a dedicated RACH resource (e.g., occasion and/or preamble) may indicate the reason for the RACH operations, here UL synchronization, and may enable the UE and network to further reduce signaling overhead.

With reference to the timing diagram in FIG. 7D, during operation the UE 115 begins a 4-step RACH operation and transmits a RACH request or Msg1 to the candidate cell (e.g., base station 105 or network entity 405, 495). The RACH operation may be performed responsive to the UE 115 determining that a timer (e.g., TA timer) associated with its SDT configuration for the candidate cell is about to expire. In the example of FIG. 7D, the Msg1 has a 1 part format. In other aspects, the Msg1 may have a 2 part format, i.e., include a part 1 and a part 2, as described with reference to FIG. 7C.

The candidate cell responds to the RACH request or Msg1 by transmitting a RACH response or Msg2 to the UE 115. The RACH response or Msg2 may include updated timing information or updated SDT configuration information that the UE 115 can use to update its timer and/or SDT configuration and perform an early synchronization operation before expiration of the timer and/or SDT configuration.

In the example of FIG. 7D, the UE 115 may not need to respond to the candidate cell with a Msg3 to indicate to the network and candidate cell that the rationale or purpose for the RACH operations was for the early synchronization operation. Rather, in the example FIG. 7D, the UE 115 uses the dedicated RACH resource to indicate to the cell and network the RACH operation is for early uplink synchronization. For example, by the UE 115 utilizing a particular PRACH preamble format, a particular time and frequency resources, and/or a particular type of RACH operation or mode, the network may determine that the RACH operation is for early update synchronization. The cell and network may then refrain from continued operation based on this indication, such as not monitor for Msg3. The early update operations may greatly reduce network overhead by enabling a UE to remain in an inactive mode and stay synched and by enabling reduced RACH operations for uplink synchronization.

Referring to FIGS. 8A and 8B, each of FIGS. 8A and 8B illustrate a timing diagram depicting an example of enhanced beam management operations for the enhanced SDT operations described herein. The examples of FIGS. 8A and 8B correspond to examples of beam management operations to support the enhanced SDT operations described herein. For example, the beam management operations may enable beam switching and recovery failure operations with a candidate cell for SDT operations in an inactive state or a non-RRC connected state.

FIG. 8A corresponds to an example of beam management operations with a network determined beam change, and FIG. 8B corresponds to an example of beam management operations with a UE determined beam change.

Referring to FIG. 8A, during operation, at 810, the base station 105 transmits beam settings information to the UE 115. For example, the base station 105 may configure the UE 115 via initial connection and/or by RRC configuration with beam information. Additionally, or alternatively, the base station 105 may configure the UE 115 with SDT specific beam information, such as with dedicated beams and/or beam switching configurations for SDT operations.

At 815, the UE 115 determines a report trigger condition. For example, the UE 115 may periodically determine whether one or more report trigger conditions are satisfied or may determine that a report trigger condition has been satisfied. The report trigger conditions may include or correspond to conventional beam reporting trigger conditions, general reporting trigger conditions, or specific SDT reporting trigger conditions. As illustrative, non-limiting examples, the report trigger condition may include one or more of a time based condition, a quality based condition, a signal strength based condition, a failure based condition, an error or error rate based condition, an interference condition, or a mobility condition. The condition may be satisfied by measurement data (e.g., SSB measurement data) or predicted future measurement data or metric, such as AI/ML derived values indicating potential future signal blockage.

Although reference signal transmission and measurement operations are not illustrated in the example of FIG. 8A, an example of such operations is illustrated in FIG. 8B, and described with reference to FIGS. 5 and 6. In some implementations, the UE 115 may determine a report trigger condition is satisfied based on the reference signal measurement information. Additionally, or alternatively, the UE 115 may determine a report condition is satisfied based on network indication. For example, the network, such as base station 105, may trigger the UE 115 to perform a beam report, that is to measure reference signals and transmit a report or to report its last measurements, based on transmission of a downlink transmission not shown in FIG. 8A or based on the original beam settings information.

At 820, the UE 115 transmits a beam report to the base station 105. For example, the UE 115 may transmit beam report information to the base station in an uplink transmission. The beam report information may be transmitted in a dedicated beam report transmission or beam report transmission for SDT, or may be transmitted in a general report transmission, such as physical layer or L1 report with other physical layer information and reports. In the example of FIG. 8A, the beam report does not indicate a beam determined, suggested, or selected by the UE. However, in other examples, such as the example of FIG. 8B, the UE 115 may indicate a preference for or a selection of a particular beam, or the UE 115 may begin using a beam without (e.g., prior to) receipt and/or acknowledgment by the base station 105.

Although not illustrated in the example of FIG. 8A, the beam report transmitted by the UE 115 may be generated based on measurements of reference signals from the candidate cell or cells, such as base station 105. An example of such reference signal transmission and measurement is described with reference to FIGS. 5 and 6 and further with reference to FIG. 8B.

At 825, the base station 105 determines a new beam for the UE 115 based on the received beam report. For example, the base station 105 may determine that a beam reported by the UE 115 satisfies a beam switch condition and/or that the beam currently used by the UE 115 satisfies a beam replacement condition. The beam related conditions may include or correspond to conventional beam switch/replacement conditions or specific SDT beam switch/replacement conditions.

At 830, the base station 105 transmits a beam change indication to the UE 115. For example, the base station 105 may configure the UE 115 with a new beam by transmitting beam change information indicating a new beam for UL, DL, or both (e.g., an UL beam and a corresponding DL beam). The new beam indication may be made directly, or by reference to a reference signal or reference beam or with reference to another parameter which is associated with a corresponding beam, such as TCI state.

The base station 105 may begin to use the new beam after determination (i.e., when sending the beam change indication at 830), after sending the beam change indication at 830 (e.g., when sending or receiving a transmission subsequent to the beam change indication at 830), or after UE acknowledgment of the beam change indication at 830 (e.g., after receipt of a beam change acknowledgment indication by the UE 115 or receipt of a transmission from the UE 115 with the new beam).

Referring to FIG. 8B, during operation, at 860, the base station 105 transmits one or more reference signal transmissions to the UE 115. For example, the base station 105 may broadcast SSB transmission for measurements by the UE 115 and other UEs. Additionally, or alternatively, the base station 105 may unicast UE specific reference signal transmissions, such as with dedicated reference signals for SDT operations, to be measure by a specific UE.

At 865, the UE 115 measures the reference signals and determines a new beam. For example, the UE 115 may periodically measure signals (e.g., SSBs) and determine whether one or more beam switch and/or replacement conditions are satisfied or may determine that a beam measurement or evaluation condition has been satisfied. Similar to as described with reference to the determined trigger at 815, the UE 115 may utilize one or more trigger conditions to initiate measurement operations, beam evaluation operations, or both.

At 870, the UE 115 transmits a beam change indication to the base station 105. For example, the UE 115 may transmit beam change information to the base station 105 in an uplink transmission. The beam change information may be transmitted in a dedicated beam change transmission or beam change report transmission for SDT, or may be transmitted in a general report transmission, such as physical layer or L1 report with other physical layer information and reports. As compared to the example of FIG. 8A, in the example of FIG. 8B the UE 115 determines the new beam change and indicates the beam change to the network or requests confirmation of the beam change from the network. The UE-determined new beam indication may be made directly, or indirectly, such as by reference to a reference signal or reference beam or with reference to another parameter which is associated with a corresponding beam, such as TCI state.

At 875, the base station 105 transmits a beam change acknowledgement to the UE 115. For example, the base station 105 may acknowledgement the beam change indicated or requested by the UE 115 by transmitting a standard acknowledgement message that it received the beam change indication transmission, or by indicating a special acknowledgement transmission indicating it successfully received and accepts the (proposed) beam change.

The UE 115 may begin to use the new beam after determination (i.e., when sending the beam change indication at 870), after sending the beam change indication at 870 (e.g., when sending or receiving a transmission subsequent to the beam change indication at 870), or after network acknowledgment of the beam change indication at 870 (e.g., after receipt of a beam change acknowledgment indication at 875 by the UE 115 or receipt of a transmission from the network with the new beam).

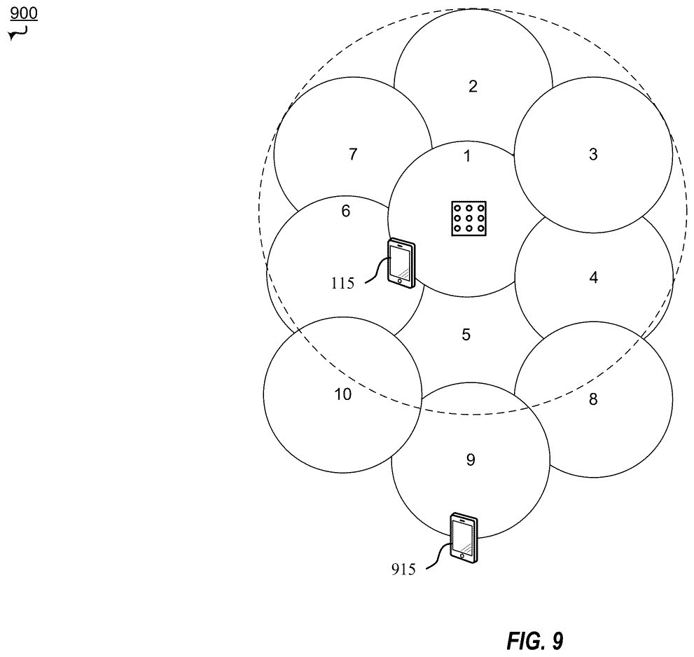

Referring to FIG. 9, FIG. 9 is a diagram 900 illustrating a wireless communication system that supports enhanced small data transmission operations according to one or more aspects. Diagram 900 of FIG. 9 depicts an example of a plurality of cells and their corresponding coverage areas. In FIG. 9, ten cells are illustrated, cell 1-cell 10, and their corresponding coverage areas are depicted as circles, with some of the circles/coverage areas overlapping each other for adjacent or neighbor cells. Additionally, a cell group coverage area that includes cells 1-7 is illustrated as a larger circle with dashed lines that encompasses the coverage areas for cells 1-7 and includes a portion of the coverage areas for cells 8-10.

In the aspects described herein, as user devices move through a network and through the coverage areas of the cells thereof, the user devices may store and release the enhanced SDT configuration information for additional, candidate cells described herein. For example, a UE may store per cell SDT configuration information for multiple nearby candidate cells and may also release this per cell SDT configuration information on a per cell, per group, or per area basis.

In the example of FIG. 9, a first UE 115 is connected to cell 1 and within range of (e.g., within the coverage area of) cells 1, 4, and 5. In such a scenario, the first UE 115 may be configured with per cell SDT configuration information for each cell that is adjacent to cell 1, here cells 2 though 7. Alternatively, the first UE 115 may be configured with per cell SDT configuration information for all cells within a certain range of the serving cell, cell 1. In such a scenario, the first UE 115 may be configured with per cell SDT configuration information for each candidate cell that is within a threshold range form cell 1 or its coverage area, or for each candidate cell that is inside of or that has a corresponding coverage area that extends within a defined per cell SDT configuration area to cell 1, here cells 2 though 7. The above examples of providing candidate cell information for candidate cells that are outside the range of a device may be supported by the aspects described herein where a serving cell or other candidate cell provides SDT configuration information for additional cells outside of itself, such as described with reference to FIG. 6.

In some other implementations, user devices may only receive candidate cell SDT configuration information directly from the candidate cell itself, such as via broadcast transmissions from the candidate cell, or from prior connections to the candidate cells. For example, in such scenarios the first UE 115 may receive first SDT configuration information from the first cell (cell 1), second SDT configuration information from the fifth cell (cell 5), and third SDT configuration information from the sixth cell (cell 6) when the first UE 115 is in the position shown in the example of FIG. 9. Additionally, in some implementations the first UE 115 may also save or retain any received per cell SDT configuration information for any of the candidate cells that are adjacent to its current serving cell of cell 1, that is any of cells 1-7, or to any of the cells that have coverage area that overlap with the coverage area shown by the dashed box, that is any of cells 1-10. For example, if the first UE 115 moved from the position of the second UE 915 to its current position in diagram 900, the UE 115 may have received candidate cell information for one or more of cells 8-10.

In the aspects herein, retention of per cell SDT configuration information for candidate cells may be limited by system resources, such as memory and/or power constraints (e.g., limited memory or buffer sizes in some modes). To address storage limitations and/or to conserve resources, devices may release stored per cell SDT configuration information on a per cell basis. Currentlly, a device only stores a single SDT configuration for its serving cell and such information is released on expiration of a TA timer and/or many other conditions (e.g., conditional handover (CHO), lower layer triggered mobility (LTM), etc.). In the aspects described herein, a device may refrain from using the conventional SDT configuration information release mechanisms and may release SDT configuration information on a per cell, per group, or per area basis responsive to conventional trigger conditions and/or responsive to additional enhanced per cell configuration release conditions, such as mobility conditions, memory limitation conditions, power saving conditions, AI/ML predictions, etc.

As one example, the second UE 915 may release its previously received per cell SDT configuration information for cells 1-7 when it leaves the coverage area of cells 1-7 and is at its current position within cell 9. Instead, the second UE 915 may receive refreshed per cell SDT configuration information for cell 9 and any cell adjacent thereto (which includes cells 4-6) from cell 9. Alternatively, the second UE 915 may receive refreshed per cell SDT configuration information for cell 9 and any other candidate cell it is in range of (e.g., additional candidate cells not shown in FIG. 9).

In some other examples, the second UE 915 may release its stored per cell SDT configuration on a per cell basis (as opposed to the per group or per area example above) of only cells that are no longer adjacent to or within range of its new serving cell of cell 9. In the example of FIG. 9, the second UE 915 may release SDT configuration information received from cells 2-4 and 5-7 as these cells are not adjacent to the current or last serving cell, cell 8, of the second UE 915.

As illustrative, non-limiting examples, instead of releasing candidate cell configurations for CHO or LTM, a UE in a non-connected state (e.g., RRC inactive) may still keep them under certain conditions. For example, candidate cell configurations can be released when a UE is outside the coverage of any candidate cell o of any group of candidate cells for more than a threshold amount of time (e.g., X ms). The threshold amount of time can be defined in the standard or indicated by the network. As another example, candidate cell configurations can be released when UE outside coverage of a candidate cell by using a cell or beam metric instead of time. To illustrate, if the corresponding cell or beam metric is below a certain threshold or below the threshold for a certain period of time, the configuration can be released. Again, the cell or beam metric (e.g., cell metric for L3 mobility, RSRP, etc.) and threshold may be defined in the standard or indicated by the network. In addition to providing enhanced SDT functionality for mobile devices and mobility scenarios, the storing of such information may provide additional benefits when transitioning to a connected mode. For example, if a large amount of traffic arrives later (e.g., after a SDT transmission), a UE can quickly transition to connected mode with CHO or LTM enabled based on the previously stored candidate cell configurations.

As described above, early synchronization operations can be applied to SDT operations to enable UL synchronization (e.g., renewal or update of TA timer) in advance of expiration to enable the UE to extend its CG-SDT configuration for one or more candidate cells. As some examples of early synchronization options, in some implementations, the PRACH transmission frequency and/or power may be limited. For example, the network or standard may fix limits or conditions for PRACH transmissions, such as Msg1 or MsgA, for the purpose of early UL synchronization operations for SDT. As an illustrative example, the network may configure the UE to refrain from transmitting more than X times within Y ms, or may configure minimum backoff timer (e.g., a second PRACH transmission should not be initiated within Y ms after the last initiated PRACH transmission). As another illustrative example, the network may configure the UE with PRACH power control and retransmission related parameters for SDT synchronization or early synchronization operations. These PRACH power control and retransmission related parameters for SDT or early update synchronization may have separate values from similar parameters for other purposes. For example, the PRACH power control and retransmission related parameters for SDT may have a smaller P0, a smaller alpha, smaller power increase per retransmission, reduced maximum amount of retransmission, or any combination thereof, as compared to standard or conventional PRACH power control and retransmission related parameter, such as those parameters for standard connection, handover, failure recovery, etc.

As another example of early synchronization options, a network or standard may configure a priority of a PRACH transmission for SDT synchronization or early update of early synchronization options as compared to a priority of other downlink and/or uplink transmission. For example, a SDT or early update synchronization PRACH transmission may have a lower priority as compared to a priority for other PRACH transmission for other purposes, as compared to a priority for other UL or DL transmissions, or both. To illustrate, if a RACH procedure is initiated for another (e.g., any other) purpose during the ongoing RACH for SDT or early UL synchronization, the SDT or early UL synchronization procedure is aborted, and the UE should initiate the other RACH procedure and continue with (potentially full) RACH procedure for the other purpose (e.g., transition to connected, handover, etc.).

As yet another example of early synchronization options, a UE may perform the updated based on a traffic arrival prediction. For example, the UE may include an AI or ML model used to determine or predict the likelihood of having an incoming or outgoing SDT. The UE may determine to perform a SDT early update synchronization operation based on the predictions, such as the output of the AI or ML model. As one illustrative, non-limiting example, the UE may determine to perform an SDT or early update synchronization operation based on a prediction confidence level (e.g., AI/ML prediction) being above a threshold, for a prediction that traffic while arrive within a particular time frame or by/after a particular time. As one example, the prediction may include whether traffic is likely to arrive within X ms after the PRACH transmission and with what probability or confidence value. The UE or network may configure or adjust conditions for performing AI or ML based triggering of SDT or early update synchronization operation. As one illustrative, non-limiting example, the UE or network may terminate the SDT or early update synchronization operation at least for Y ms if the prediction performance accuracy is below a threshold.

As described above, beam management can be applied to SDT operations to refine or update beams for SDT operations and transmissions as compared with the initial beam configured for CG or RA-based SDT operations. The beam management related configuration information can be provided in or with the SDT configuration information per candidate cell or for all SDT configurations. In addition, a UE does not release stored UE configurations after a beam switch.

As some examples of beam management options for SDT operations and inactive UEs, in some network-side led implementations the UE reporting is scheduled by the network and can be periodic, semi-periodic (e.g., semi-static), or aperiodic (e.g., dynamic). In some other network-side led implementations, the UE reporting is an event-triggered report (with UE determination) but with a triggering condition configured by the network. Alternatively, in some additional network-side led implementations, the network may use a combination of network scheduled and UE event triggered, where the UE and/or the network may define a triggering condition. In such network-side led implementations, the network determines the refined/updated beam based on UE report.

The refined/updated beam may be indicated to the UE by a corresponding reference signal or TCI state. In some examples, the beam report by the UE and/or the beam change indication by the network can be separate for different modes or directions (e.g., DL and UL) to achieve best throughput or RSRP per mode and/or direction. Additionally, in some such examples, the UE, the network, or both may employ an AI or ML model to generate the report or to determine the beam change. For example, the UE or the network may utilize an AI or ML model to predict a beam change measurement value or metric at some future time instance, and the predicted value is then used to determine a beam change. As another example, the network may employ an AI or ML model to determine a beam change based on the received UE report information, and optionally based on any AI or ML predicted information for the future.

As a simple example, in case of CG based SDT, the network can update the SSB ID associated with the used CG occasion based on an event triggered SSB L1-RSRP report. To illustrate, the UE triggers the report when a new SSB2 becomes better than the current SSB1 and, based on the report, and the network indicates the UE to use the CG occasion associated with the new SSB2. As illustrative, non-limiting examples of report triggering events or event conditions, the report triggering event may include a determination that a new SSB quality is X dB better than current SSB quality.

In some examples, the UE triggered report (e.g., inactive beam report or SDT beam report) may be carried in MAC-CE from the UE, or another UL transmission, such as a PUCCH or PUSCH. Additionally, or alternatively, the network may indicate the new SSB ID in a DCI or MAC-CE transmission, which can be, optionally, further acknowledged by the UE.

As some additional examples of beam management options for SDT operations and inactive UEs, the UE may perform the beam change determination, and such examples may be referred to as UE-side led implementations (as opposed to the network-side led implementations in the above examples). In the UE-side led implementations, the UE may determine the updated beam based on candidate reference signal measurements, e.g. SSBs, and the UE may refrain from reporting the candidate reference signal measurements to the network (e.g., does not send a beam measurement report).

Similar to network-side led implementations described above, the UE-side led implementations may also indicate the new beam by indicating or referring to a corresponding reference signal or TCI state, which in turn indicates the beam by based on the association of a beam with each reference signal and/or TCI state. Again, and similar to network-side led implementations described above, the UE-side led implementations may provide separate new beam indications for different directions (e.g., DL and UL directions) or modes to achieve best throughput or RSRP per direction and/or mode.

Additionally, in some such examples, the UE may employ an AI or ML model (or models) to generate the predicted measurement or metric values for a future time, to determine the beam change, or both. For example, the UE may utilize an AI or ML model to predict a beam change measurement value or metric at some future time instance, and the predicted value is then used to determine a beam change. As another example, the UE may employ an AI or ML model to determine a beam change based on the measurement information, and optionally based on any AI or ML predicted information for the future.

As a simple example, in case of CG-based SDT operations, the UE can update the SSB ID associated with the used CG occasion based on an event triggered beam switch command, e.g. UE sends the command when a new SSB2 becomes better than the current SSB1 and, based on the command, both sides will use the CG occasion associated with the new SSB2. The beam switch command trigger may be similar to the beam switch command triggers for network-side led operations. As one example, a triggered beam switch command may be carried in MAC-CE from the UE, and the beam switch command can be further acknowledged by the network, e.g. via DCI with special bit sequence. The special bit sequence may include or correspond to an UL grant scheduling new data with same HARQ ID as the beam switch command.

In some such UE-side led implementations, the command from the UE and the acknowledgement from the network are sent via the old beam, and both devices switch to the new beam after the acknowledgement. In some other such UE-side led implementations, the command from the UE and the acknowledgement from the network are sent via the new beam, and both devices or sides switch to the new beam (or beams) when transmitting their respective transmissions. In such examples, the beam switch command from the UE carries additional information over the delayed use example, that is additional information in addition to the new beam indicator. To illustrate, the beam switch command may carry at least the UE ID, e.g. C-RNTI, such that network can identify from which UE the beam switch command corresponds to.

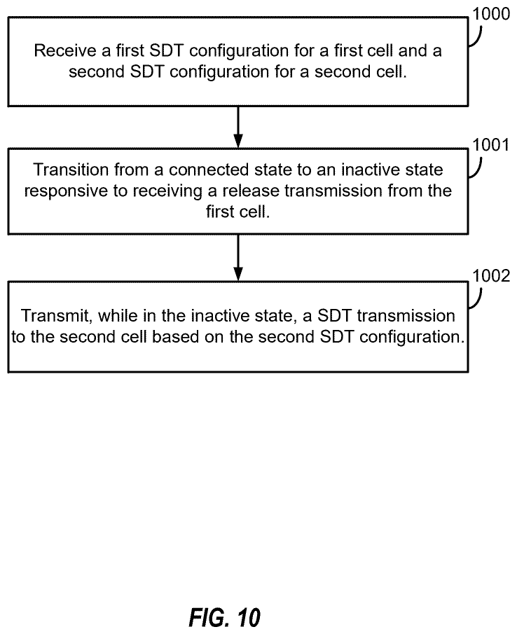

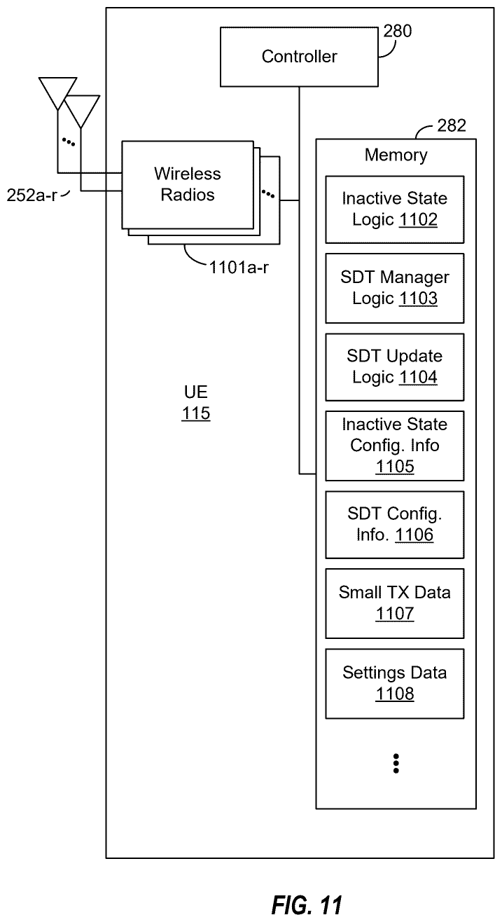

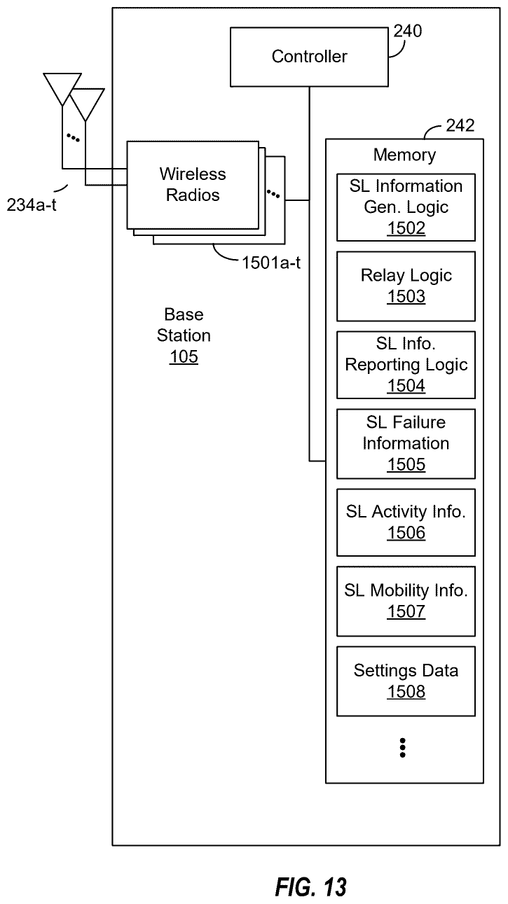

FIG. 10 is a flow diagram illustrating example blocks executed by a UE configured according to an aspect of the present disclosure. The example blocks will also be described with respect to UE 115 as illustrated in FIG. 11. FIG. 11 is a block diagram illustrating UE 115 configured according to one aspect of the present disclosure. UE 115 includes the structure, hardware, and components as illustrated for UE 115 of FIG. 2. For example, UE 115 includes controller/processor 280, which operates to execute logic or computer instructions stored in memory 282, as well as controlling the components of UE 115 that provide the features and functionality of UE 115. UE 115, under control of controller/processor 280, transmits and receives signals via wireless radios 1100a-r and antennas 252a-r. Wireless radios 1100a-r includes various components and hardware, as illustrated in FIG. 2 for UE 115, including modulator/demodulators 254a-r, MIMO detector 256, receive processor 258, transmit processor 264, and TX MIMO processor 266. As illustrated in the example of FIG. 11, memory 282 inactive state logic 1102, SDT manager logic 1103, SDT update logic 1104, inactive state configuration information 1105, SDT configuration information 1106, small transmission data 1107, and settings data 1108.

At block 1000, a wireless communication device, such as a UE, receives a first SDT configuration for a first cell and a second SDT configuration for a second cell. For example, the UE 115 receives a first SDT configuration for a first cell and a second SDT configuration for a second cell, as described with reference to FIGS. 4-9. To illustrate, the UE 115 receives the first SDT configuration 452 for a first cell and the second SDT configuration 454 for a second cell from either of the network entity 405 or the second network entity 495 in a RRC release message or an RRC configuration message, or via a combination thereof. As another illustration, the UE 115 receives the first SDT configuration 452 for a first cell from the first cell in first transmission and receives the second SDT configuration 454 for a second cell from the second cell in a second transmission. Other examples are described in FIGS. 4-9.

At block 1001, the UE 115 transitions from a connected state to an inactive state responsive to receiving a release transmission from the first cell. For example, the UE 115 transitions from a RRC connected state to an RRC inactive state responsive to receiving the first SDT configuration 452, the second SDT configuration 454, or both, from either of the network entity 405 or the second network entity 495, as described with reference to FIGS. 4-9. To illustrate, the UE 115 transitions from the RRC connected state to the RRC inactive state in response to a RRC release message with a suspend configuration (suspendconfig information element) from the primary cell, such as the network entity 405.

At block 1002, the UE 115 transmits, while in the inactive state, a SDT transmission to the second cell based on the second SDT configuration. For example, the UE 115 transmits the SDT transmission 456 to the second cell (e.g., second network entity 495) based on the second SDT configuration for the second cell, which was received from the first cell (e.g., network entity 405), and while in the RRC inactive state, as described with reference to FIGS. 4-9. The SDT transmission 456 may be generated based on the SDT configuration information 408 and/or the inactive state configuration information 442. Other examples are described in FIGS. 4-9. The UE 115 may transmit other SDTs to other cells based on having multiple SDT configurations for multiple cells or a single SDT configuration for multiple cells. The UE 115 may experience a mobility event and determine to switch cell from the first cell to the second cell in some aspects. The UE 115 may also update its SDT configuration (e.g., TA timer) before or after the SDT transmission as described with reference to FIGS. 7A-7D.

The UE 115 may execute additional blocks (or the UE 115 may be configured further perform additional operations) in other implementations. For example, the UE 115 may perform one or more operations described above. As another example, the UE 115 may perform one or more aspects as described below.

In a first aspect, a device for wireless communication includes: at least one processor; and a memory coupled to the at least one processor. The at least one processor is configured to cause the device to: receive a first SDT configuration for a first cell and a second SDT configuration for a second cell; transition from a connected state to an inactive state responsive to receiving a release transmission from the first cell; and transmit, while in the inactive state, a SDT transmission to the second cell based on the second SDT configuration.

In a second aspect, alone or in combination with one or more of the above aspects, the second SDT configuration includes: configured grant based SDT configurations and a corresponding time alignment (TA) timer configuration; a SDT search space configuration; a cell specific configuration for downlink direct grant operations; a cell specific configuration for uplink direct grant operations; RACH configuration for SDT operations; or any combination thereof.

In a third aspect, alone or in combination with one or more of the above aspects, the first SDT configuration for the first cell and the second SDT configuration for the second cell correspond to per cell SDT configurations, or wherein the first SDT configuration and the second SDT configuration are part of a multiple cell SDT configuration for a cell group.

In a fourth aspect, alone or in combination with one or more of the above aspects, the at least one processor configured to receive the first SDT configuration for the first cell and the second SDT configuration for the second cell includes to: receive the first SDT configuration and the second SDT configuration from the first cell in a single transmission.

In a fifth aspect, alone or in combination with one or more of the above aspects, the single transmission comprises the RRC release transmission or a system information block (SIB) transmission.

In a sixth aspect, alone or in combination with one or more of the above aspects, the at least one processor is configured to receive the first SDT configuration for the first cell and the second SDT configuration for the second cell includes to: receive the first SDT configuration from the first cell in a first transmission; and receive the second SDT configuration from the second cell a second transmission.

In a seventh aspect, alone or in combination with one or more of the above aspects, the first and second transmissions each correspond to a system information block (SIB) transmission.

In an eighth aspect, alone or in combination with one or more of the above aspects, the first transmission comprises the RRC release transmission, and wherein the second transmission comprises a system information block (SIB) transmission.

In a ninth aspect, alone or in combination with one or more of the above aspects, the at least one processor is further configured to: perform, while in the inactive state, a random access channel (RACH) operation based on the second SDT configuration; and update a time alignment timer associated with the second SDT configuration based on the RACH operation.

In a tenth aspect, alone or in combination with one or more of the above aspects, the at least one processor configured to perform the RACH operation based on the second SDT configuration includes to: transmit a RACH preamble to the second cell; receive a RACH response from the second cell including time alignment (TA) timer information and responsive to the transmission of the RACH preamble; update a TA timer for the second cell based on the TA timer information; and transmit a PUSCH transmission to the second cell indicating an uplink synchronization operation and responsive to the RACH response, wherein the transmission of the PUSCH transmission completes the RACH operation for uplink synchronization (e.g., refrain from transmitting Msg 4 of 4-step RACH).

In an eleventh aspect, alone or in combination with one or more of the above aspects, the at least one processor configured to perform the RACH operation based on the second SDT configuration includes to: transmit a RACH preamble and a PUSCH transmission to the second cell in a single transmission, wherein the PUSCH transmission indicates an uplink synchronization operation; receive a RACH response from the second cell including time alignment (TA) timer information and responsive to the transmission of the RACH preamble, wherein the reception of the RACH response completes the RACH operation for the uplink synchronization operation; and update a TA timer for the second cell based on the TA timer information.

In a twelfth aspect, alone or in combination with one or more of the above aspects, the at least one processor configured to perform the RACH operation based on the second SDT configuration includes to: transmit a RACH preamble to the second cell, wherein the RACH preamble includes a first part and a second part, and wherein at least the first part indicates an uplink synchronization operation; receive a RACH response from the second cell including time alignment (TA) timer information and responsive to the transmission of the RACH preamble, wherein the reception of the RACH response completes the RACH operation for the uplink synchronization operation; and update a TA timer for the second cell based on the TA timer information.

In a thirteenth aspect, alone or in combination with one or more of the above aspects, the at least one processor configured to perform the RACH operation based on the second SDT configuration includes to: transmit a RACH preamble to the second cell based on the second SDT configuration, wherein the RACH preamble corresponds to a dedicated RACH resource for uplink synchronization that indicates an uplink synchronization operation; receive a RACH response from the second cell including time alignment (TA) timer information and responsive to the transmission of the RACH preamble, wherein the reception of the RACH response completes the RACH operation for the uplink synchronization operation; and update a TA timer for the second cell based on the TA timer information.

In a fourteenth aspect, alone or in combination with one or more of the above aspects, the second SDT configuration includes PRACH transmission frequency configuration information, PRACH transmission power configuration information, PRACH transmission power configuration information, AI or ML traffic arrival prediction configuration information, or any combination thereof.

In a fifteenth aspect, alone or in combination with one or more of the above aspects, the at least one processor is further configured to: perform, while in the inactive state, a beam management operation based on the second SDT configuration, wherein a second beam used to transmit the SDT transmission to the second cell is different from a first beam configured by the second SDT configuration.

In a sixteenth aspect, alone or in combination with one or more of the above aspects, the at least one processor is further configured to: receive one or more reference signal transmissions from the second cell; generate measurement information for the one or more reference signal transmissions based on measurement operations on the one or more reference signal transmissions; transmit a measurement report based on the generated measurement information for the one or more reference signal transmissions; and receive a beam switch command from the second cell responsive to transmission of the measurement report.

In a seventeenth aspect, alone or in combination with one or more of the above aspects, the at least one processor is further configured to: receive one or more reference signal transmissions from the second cell; generate measurement information for the one or more reference signal transmissions based on measurement operations on the one or more reference signal transmissions; determine whether to switch beams based on the measurement information; and transmit a beam switch command to the second cell based on a determination to switch beams.

In an eighteenth aspect, alone or in combination with one or more of the above aspects, the beam switch command is sent using a different beam than a beam indicated by the beam switch command.

In a nineteenth aspect, alone or in combination with one or more of the above aspects, the beam switch command is sent using a second beam indicated by the beam switch command.

In a twentieth aspect, alone or in combination with one or more of the above aspects, the second SDT configuration includes beam reporting configuration information, beam switch configuration information, AI or ML future state prediction configuration information, or any combination thereof.

In a twenty-first aspect, alone or in combination with one or more of the above aspects, a method of wireless communication includes receiving a first SDT configuration for a first cell and a second SDT configuration for a second cell; transitioning from a connected state to an inactive state responsive to receiving a release transmission from the first cell; and transmitting, while in the inactive state, a SDT transmission to the second cell based on the second SDT configuration. Other aspects and features are also claimed and described.

Accordingly, a UE and a base station may perform enhanced SDT operations. By performing enhanced SDT operations, latency and failures may be reduced and SDT operations may be improved when operating in an inactive state and/or for mobility scenarios.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-15 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A device for wireless communication, comprising:
at least one processor; and
a memory coupled to the at least one processor,
wherein the at least one processor is configured to:
receive a first SDT configuration for a first cell and a second SDT configuration for a second cell;
transition from a connected state to an inactive state responsive to receiving a release transmission from the first cell; and
transmit, while in the inactive state, a SDT transmission to the second cell based on the second SDT configuration.

2. The device of claim 1, wherein the second SDT configuration includes:
configured grant based SDT configurations and a corresponding time alignment (TA) timer configuration;
a SDT search space configuration;
a cell specific configuration for downlink direct grant operations;
a cell specific configuration for uplink direct grant operations;
RACH configuration for SDT operations; or
any combination thereof.

3. The device of claim 1, wherein the first SDT configuration for the first cell and the second SDT configuration for the second cell correspond to per cell SDT configurations, or wherein the first SDT configuration and the second SDT configuration are part of a multiple cell SDT configuration for a cell group.

4. The device of claim 1, wherein the at least one processor configured to receive the first SDT configuration for the first cell and the second SDT configuration for the second cell includes to:
receive the first SDT configuration and the second SDT configuration from the first cell in a single transmission.

5. The device of claim 4, wherein the single transmission comprises the RRC release transmission or a system information block (SIB) transmission.

6. The device of claim 1, wherein the at least one processor is configured to receive the first SDT configuration for the first cell and the second SDT configuration for the second cell includes to:
receive the first SDT configuration from the first cell in a first transmission; and
receive the second SDT configuration from the second cell a second transmission.

7. The device of claim 6, wherein the each of the first transmission and the second transmission correspond to a system information block (SIB) transmission.

8. The device of claim 6, wherein the first transmission comprises the RRC release transmission, and wherein the second transmission comprises a system information block (SIB) transmission.

9. The device of claim 1, wherein the at least one processor is further configured to:
perform, while in the inactive state, a random access channel (RACH) operation based on the second SDT configuration; and
update a time alignment timer associated with the second SDT configuration based on the RACH operation.

10. The device of claim 9, wherein the at least one processor configured to perform the RACH operation based on the second SDT configuration includes to:
transmit a RACH preamble to the second cell;
receive a RACH response from the second cell including time alignment (TA) timer information and responsive to the transmission of the RACH preamble;
update a TA timer for the second cell based on the TA timer information; and
transmit a PUSCH transmission to the second cell indicating an uplink synchronization operation and responsive to the RACH response, wherein the transmission of the PUSCH transmission completes the RACH operation for uplink synchronization.

11. The device of claim 9, wherein the at least one processor configured to perform the RACH operation based on the second SDT configuration includes to:
transmit a RACH preamble and a PUSCH transmission to the second cell in a single transmission, wherein the PUSCH transmission indicates an uplink synchronization operation;
receive a RACH response from the second cell including time alignment (TA) timer information and responsive to the transmission of the RACH preamble, wherein the reception of the RACH response completes the RACH operation for the uplink synchronization operation; and
update a TA timer for the second cell based on the TA timer information.

12. The device of claim 9, wherein the at least one processor configured to perform the RACH operation based on the second SDT configuration includes to:
transmit a RACH preamble to the second cell, wherein the RACH preamble includes a first part and a second part, and wherein at least the first part indicates an uplink synchronization operation;
receive a RACH response from the second cell including time alignment (TA) timer information and responsive to the transmission of the RACH preamble, wherein the reception of the RACH response completes the RACH operation for the uplink synchronization operation; and
update a TA timer for the second cell based on the TA timer information.

13. The device of claim 9, wherein the at least one processor configured to perform the RACH operation based on the second SDT configuration includes to:
transmit a RACH preamble to the second cell based on the second SDT configuration, wherein the RACH preamble corresponds to a dedicated RACH resource for uplink synchronization that indicates an uplink synchronization operation;
receive a RACH response from the second cell including time alignment (TA) timer information and responsive to the transmission of the RACH preamble, wherein the reception of the RACH response completes the RACH operation for the uplink synchronization operation; and
update a TA timer for the second cell based on the TA timer information.

14. The device of claim 1, wherein the second SDT configuration includes PRACH transmission frequency configuration information, PRACH transmission power configuration information, PRACH transmission power configuration information, AI or ML traffic arrival prediction configuration information, or any combination thereof.

15. The device of claim 1, wherein the at least one processor is further configured to:
perform, while in the inactive state, a beam management operation based on the second SDT configuration, wherein a second beam used to transmit the SDT transmission to the second cell is different from a first beam configured by the second SDT configuration.

16. The device of claim 1, wherein the at least one processor is further configured to:
receive one or more reference signal transmissions from the second cell;
generate measurement information for the one or more reference signal transmissions based on measurement operations on the one or more reference signal transmissions;
transmit a measurement report based on the generated measurement information for the one or more reference signal transmissions; and
receive a beam switch command from the second cell responsive to transmission of the measurement report.

17. The device of claim 1, wherein the at least one processor is further configured to:
receive one or more reference signal transmissions from the second cell;
generate measurement information for the one or more reference signal transmissions based on measurement operations on the one or more reference signal transmissions;
determine whether to switch beams based on the measurement information; and
transmit a beam switch command to the second cell based on a determination to switch beams.

18. The device of claim 16, wherein the beam switch command is sent using a different beam than a beam indicated by the beam switch command.

19. The device of claim 17, wherein the beam switch command is sent using a second beam indicated by the beam switch command.

20. The device of claim 1, wherein the second SDT configuration includes beam reporting configuration information, beam switch configuration information, AI or ML future state prediction configuration information, or any combination thereof.
